(19) United States
(12) Patent Application Publication
(10) Pub. No.: US 2016/0348357 A1
(43) Pub. Date: Dec. 1, 2016

(54) FIRE RESISTANT FRAMING ACCESSORY

(71) Applicant: Clarkwestern Dietrich Building Systems LLC, West Chester, OH (US)

(72) Inventors: Jeremy Ryan Smith, Carrollton, VA (US); Gregg Allan Stahl, Lebanon, OH (US); Adam J. Shoemaker, West Chester, OH (US)

(21) Appl. No.: 15/166,657

(22) Filed: May 27, 2016

Related U.S. Application Data
(60) Provisional application No. 62/166,826, filed on May 27, 2015.

(51) Int. Cl. E04B 1/94; B29C 47/06; B29C 47/00; E04B 2/56; C09K 21/14

(52) U.S. Cl. CPC E04B 1/948; E04B 2/56; C09K 21/14; B29C 47/0019; B29C 47/0004; B29C 47/065; B29K 2995/0016; B29K 2027/06

(57) ABSTRACT

A framing accessory at least a portion of which comprises a fire resistant material. In some embodiments, a first portion of the framing accessory comprises fire resistant material, while a second portion comprises non-fire resistant material. In other embodiments, the entire framing accessory may be made of fire resistant material. The framing accessory may be formed, such as by molding, injection molding, extrusion, or co-extrusion, as a single, unitary structure. In one embodiment, the framing accessory may comprise a control joint, wherein the central portion of the control joint comprises fire resistant material. In another embodiment, the framing accessory may comprise a cap installed between a header track and a ceiling as part of a fire-rated wall assembly. The cap may comprise a U-shaped profile and the header track may be received within an interior cavity of the cap.

### PRIORITY

This application claims priority to U.S. Provisional Patent Application Ser. No. 62/166,826, filed May 27, 2015, entitled “FIRE RESISTANT FRAMING ACCESSORY,” the disclosure of which is incorporated by reference herein.

### BACKGROUND

In typical building construction, framing assemblies, including studs, joists, trusses, etc., are combined with sheathing materials, such as wallboard panels, to form sheathing assemblies and are used to construct walls, ceilings and/or floors. The sheathing materials on their own may not provide the desired level of fire protection, particularly at the joints or ends of the sheathing assemblies, such as the joint formed by adjacent sheathing assemblies along the length of a wall, the joint formed between the top of a wall and the ceiling, or the joint formed between the bottom of a wall and the floor. As a result, additional materials, such as mineral wool, fire caulking, intumescent strips, intumescent putty, fire resistant foam, or other fire resistant materials may be installed at these joints in order to achieve the desired level of fire protection. Various types of framing accessories are also often utilized in these joints, including but not limited to control joints, architectural reveals, expansion joints, and end caps. These framing accessories may be manufactured from plastics, metals, paper products, composites and other materials. Accordingly, providing a framing accessory that comprises fire resistant material may allow a single component to replace multiple components or materials, which may reduce installation time and total material cost.

While a variety of framing accessories and fire resistant construction materials have been made and used, it is believed that no one prior to the inventor has made or used an invention as described herein.

### BRIEF DESCRIPTION OF THE DRAWINGS

It is believed the present invention will be better understood from the following description of certain examples taken in conjunction with the accompanying drawings, in which like reference numerals identify the same elements and in which:

FIG. 1 depicts a side elevational view of an extruder for making a framing accessory that includes fire resistant material;

FIG. 2 depicts a side elevational view of a co-extruder for making a framing accessory that includes fire resistant material;

FIG. 3A depicts a side elevational view of an embodiment of a framing accessory that includes fire resistant material;

FIG. 3B depicts a side elevational view of an alternate embodiment of a framing accessory that includes fire resistant material;

FIG. 3C depicts a side elevational view of another alternate embodiment of a framing accessory that includes fire resistant material;

FIG. 4 depicts a top perspective view of a wall assembly that includes an embodiment of a framing accessory that includes fire resistant material;

FIG. 5 depicts a top perspective view of the framing accessory of FIG. 4;

FIG. 6 depicts a top plan view of the framing accessory of FIG. 4;

FIG. 7 depicts a top perspective view of an alternate wall assembly that includes an alternate embodiment of a framing accessory that includes fire resistant material;

FIG. 8 depicts a top perspective view of the framing accessory of FIG. 7;

FIG. 9 depicts a top perspective view of an alternate embodiment of the framing accessory of FIG. 8;

FIG. 10 depicts a top plan view of the framing accessory of FIG. 7;

FIG. 11 depicts a top perspective view of another alternate wall assembly that includes another alternate embodiment of a framing accessory that includes fire resistant material;

FIG. 12 depicts a top perspective view of an alternate embodiment of the framing accessory of FIG. 11;

FIG. 13 depicts a top perspective view of the framing accessory of FIG. 11;

FIG. 14 depicts a top plan view of the framing accessory of FIG. 11;

FIG. 15 depicts a top perspective view of another alternate wall assembly that includes another alternate embodiment of a framing accessory that includes fire resistant material;

FIG. 16 depicts a top perspective view of an alternate embodiment of the framing accessory of FIG. 15;

FIG. 17 depicts a top perspective view of the framing accessory of FIG. 15;

FIG. 18 depicts a top perspective view of another alternate embodiment of the framing accessory of FIG. 15;

FIG. 19 depicts a top plan view of the framing accessory of FIG. 15;

FIG. 20 depicts a top perspective view of another alternate wall assembly that includes another alternate embodiment of a framing accessory that includes fire resistant material;

FIG. 21 depicts a top perspective view of the framing accessory of FIG. 20;

FIG. 22 depicts a top perspective view of an alternate embodiment of the framing accessory of FIG. 20;

FIG. 23 depicts a top plan view of another alternate embodiment of the framing accessory of FIG. 20;

FIG. 24 depicts a bottom perspective view of another alternate wall assembly that includes another alternate embodiment of a framing accessory that includes fire resistant material;

FIG. 25 depicts a top perspective view of the framing accessory of FIG. 24;

FIG. 26 depicts a top perspective view of an alternate wall assembly that includes an alternate embodiment of the framing accessory of FIG. 24. The framing accessory depicted in FIG. 29 includes a removable strip;

FIG. 27 depicts a top perspective view of an alternate embodiment of the framing accessory of FIG. 26;

FIG. 28 depicts a top perspective view of the framing accessory of FIG. 26;

FIG. 29 depicts a side elevational view of the framing accessory of FIG. 26;

FIG. 30 depicts a top perspective view of another alternate wall assembly that includes another alternate embodiment of a framing accessory that includes fire resistant material;

FIG. 31 depicts a top perspective view of the framing accessory of FIG. 30;

FIG. 32 depicts a top plan view of the framing accessory of FIG. 30;

FIG. 33 depicts a top perspective view of another alternate wall assembly that includes another alternate embodiment of a framing accessory that includes fire resistant material;

FIG. 34 depicts a top perspective view of the framing accessory of FIG. 33;

FIG. 35 depicts a top plan view of the framing accessory of FIG. 33;

FIG. 36 depicts a top perspective view of another alternate wall assembly that includes another alternate embodiment of a framing accessory that includes fire resistant material;

FIG. 37 depicts a top perspective view of the framing accessory of FIG. 36;

FIG. 38 depicts a top plan view of the framing accessory of FIG. 36;

FIG. 39 depicts a top perspective view of another alternate wall assembly that includes another alternate embodiment of a framing accessory that includes fire resistant material;

FIG. 40 depicts a top perspective view of the framing accessory of FIG. 39;

FIG. 41 depicts a top perspective view of an alternate embodiment of the framing accessory of FIG. 39;

FIG. 42 depicts a top plan view of the framing accessory of FIG. 39;

FIG. 43 depicts a top perspective view of another alternate wall assembly that includes another alternate embodiment of a framing accessory that includes fire resistant material;

FIG. 44 depicts a top perspective view of the framing accessory of FIG. 43;

FIG. 45 depicts a top plan view of the framing accessory of FIG. 43;

FIG. 46 depicts a top perspective view of another alternate wall assembly that includes another alternate embodiment of a framing accessory that includes fire resistant material;

FIG. 47 depicts a top perspective view of an alternate embodiment of the framing accessory of FIG. 46;

FIG. 48 depicts a top perspective view of the framing accessory of FIG. 46;

FIG. 49 depicts a top plan view of the framing accessory of FIG. 46;

FIG. 50 depicts a top perspective view of another alternate wall assembly that includes another alternate embodiment of a framing accessory that includes fire resistant material;

FIG. 50A depicts a detailed view of a portion of the wall assembly of FIG. 50;

FIG. 51 depicts a cross-sectional view of the wall assembly of FIG. 50;

FIG. 52 depicts a top perspective view of the framing accessory of FIG. 50;

FIG. 53 depicts a front plan view of the framing accessory of FIG. 50;

FIG. 54 depicts another alternate wall assembly that includes the framing accessory of FIG. 50 installed on a slotted header track; and

FIG. 54A depicts a detailed view of a portion of the wall assembly of FIG. 54.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

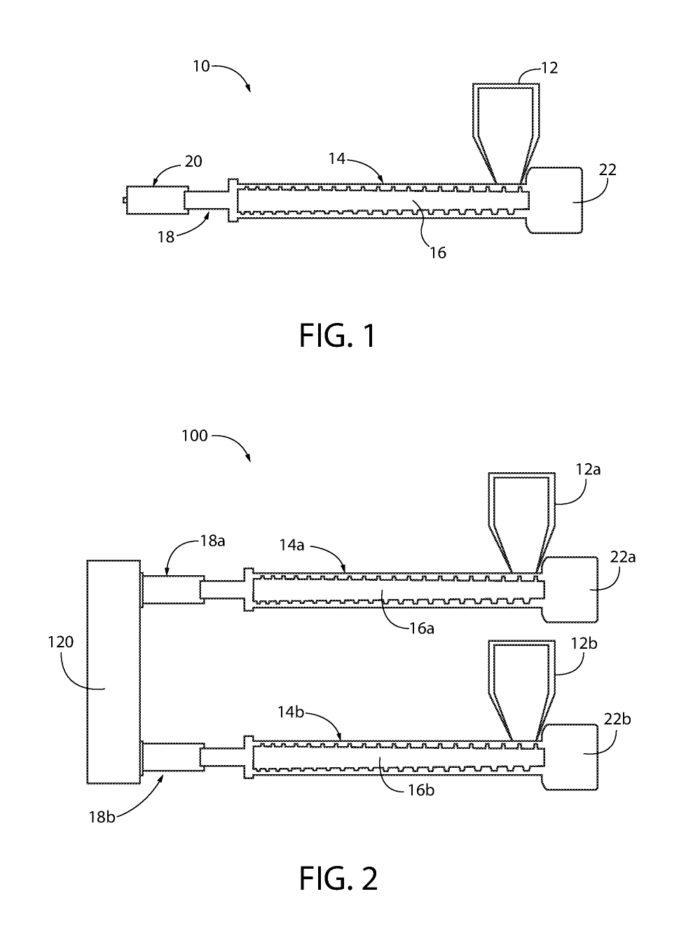

FIG. 1 shows an extruder (10) that can be used to make fire resistant framing accessories that incorporate fire resistant material. Extruder (10) of the illustrated embodiment shows a hopper (12) to feed raw material, which may include fire resistant material or components thereof, into barrel (14) of extruder (10). A rotating screw (16) positioned within barrel (14) then pushes the material through extruder (10) to a feeder (18). Barrel (14) may be heated to melt the material. In the present embodiment, screw (16) is actuated by motor (22). Feeder (18) thereby directs the material into die (20), where the material is shaped into a desired profile. The resulting framing accessory comprises a body that is formed at least partially of fire resistant material and has the desired profile. In some embodiments substantially the entire body of the framing accessory is formed of fire resistant material. The profile may be configured to allow the framing accessory, and particularly the portion(s) formed of fire resistant material, to expand into an adjacent space when the framing accessory is exposed to an elevated temperature. Once the material is shaped into the profile, the framing accessory is cooled. The framing accessory can be cooled with air and/or water with a constant tension puller.

In some embodiments the framing accessory may be formed with fire resistant material or a combination of fire resistant material and non-fire resistant material. The framing accessory may be formed via any suitable production process, including but not limited to molding, injection molding, extrusion and coextrusion. In those embodiments, the fire resistant framing accessory may be self-contained in that the fire resistant material is incorporated within the framing accessory itself, as opposed to having a separate fire resistant material attached to or applied to the outer surface of the framing accessory. The fire resistant material incorporated within framing accessory may comprise a substantially uniform material with fire resistant properties. The fire resistant material may also be incorporated within the framing accessory such that the fire resistant material is dispersed throughout the fire resistant portion of the framing accessory. In embodiments where the entire framing accessory is made out of fire resistant material, the fire resistant material may be dispersed throughout substantially the entire framing accessory. The fire resistant material can have intumescent properties that allow the material to expand and, in some embodiments char, in response to being subjected to elevated temperatures in order to resist fire. By way of example only, in some embodiments, the fire resistant material may be configured to expand when it is exposed to temperatures at or above about 300 degrees Fahrenheit. In some embodiments, the fire resistant material may fully intumesce when exposed to temperatures at or above about 375 degrees Fahrenheit. This can provide the desired fire protection level at the various joints and as part of the various wall assemblies as desired.

The fire resistant material may comprise a structural component and a fire resistant component. The structural component and the fire resistant component may be chemically combined or physically combined using any suitable method, including but not limited to mixing, blending, compounding, chemically bonding, cross-polymerization, and cross-linking the two components. The structural component and the fire resistant component may be substantially homogeneously combined. The fire resistant material may also include one or more fillers, one or more colorants, one or more stabilizers, or other additional components depending on the desired application. The structural component and the fire resistant component may be combined in different proportions depending on the desired application for a particular framing accessory that incorporates the fire resistant material.

The structural component may be configured to provide the framing accessory, or at least the portion(s) of the framing accessory comprising the fire resistant material, with a desired level of strength and rigidity. For example, in some embodiments, the fire resistant material provides sufficient strength and rigidity by itself such that the resulting self-contained fire resistant framing accessory does not require either an additional reinforcing member/layer on the fire resistant portion(s) or that the fire resistant material be applied to a separate substrate. In addition, in some embodiments, the fire resistant material provides sufficient strength and rigidity so that the self-contained fire resistant framing accessory maintains its cross-sectional profile. Furthermore, unlike intumescent tape or putty used in some prior art devices, in some embodiments, the structural component may render the portion(s) of the framing accessory comprising the fire resistant material substantially incompressible. The substantially incompressible quality of the fire resistant portion(s) of the framing accessory in these embodiments may help prevent the fire resistant material from being scratched or gouged during shipping and/or installation. The substantially incompressible quality of framing accessory in these embodiments may help prevent the fire resistant material from being scratched or gouged during shipping and/or installation. By way of example only, in some embodiments, the desired strength, rigidity and incompressibility may be achieved by using a fire resistant material comprising a structural component combined with a fire resistant component, such as a nanocomposite material with fire resistant properties, that has a density of about 1.3 grams per cubic milliliter to about 1.7 grams per cubic milliliter, and preferably about 1.4 grams per cubic milliliter

The structural component may comprise a plastic, such as polyvinyl chloride (PVC) which may be hard PVC or soft PVC, polyethylene terephthalate (PET), acrylonitrile butadiene styrene (ABS), ethylene vinyl acetate (EVA), polyethylene (PE) which may be low density (LD) or high density (HD), polypropylene (PP), polystyrene (PS), an elastomer, other suitable materials, or combinations thereof. In some embodiments, the structural component may comprise a thermosetting polymer, a thermoplastic or a combination of at least one thermosetting polymer and at least one thermoplastic.

The fire resistant component may comprise graphite, sodium silicates, other additives, or combinations thereof. In some embodiments, the fire resistant component may comprise a nanocomposite material with fire resistant properties, including but not limited to IntuPlas and/or BernoGraph, which are sold by Pyrophobic Systems Ltd. of Barrie, Ontario, Canada. By way of example only, the fire resistant component may comprise a composition such as those described in US. Patent Publication No. 2012/022201, published Jan. 26, 2012 to Zhvanetskiy et al., the entirety of which is incorporated herein by reference. Other examples of materials that could be used as the structural component and/or the fire resistant component of the fire resistant material, include but are not limited to: Charmor™, which is sold by Perstorp Holding AB of Malmo, Sweden; Delphi Intumescent Material, which is sold by Delphi Automotive LLC of Gillingham, Kent, United Kingdom; intumescent PVC materials sold by Dugdale Limited of Sowerby Bridge, West Yorkshire, United Kingdom; PVC granules sold by Hangzhou Juntai Plastic Products Co., Ltd. of Hangzhou, Zheijang, China; and FireCarb, which is sold by LKAB Minerals AB of Lulea, Sweden.

By incorporating the fire resistant material into the framing accessory itself, the need for multi-piece fire resistant assemblies and/or separate fire resistant materials that are applied to or attached to a non-fire resistant framing accessory or other part of the wall assembly, such as mineral wool, fire caulking, intumescent strips, intumescent putty, fire resistant foam, or other fire resistant materials, may be eliminated. The combining of these functions may also reduce installation time and total material cost. For example, in some prior art fire resistant wall assemblies, a strip of intumescent tape is attached to a metal header track, while in others a separate control joint backer, consisting of intumescent tape attached to a metal or vinyl support member, is installed in a wall assembly behind a conventional control joint. Unlike those prior art fire resistant wall assemblies, some embodiments of the present invention provide self-contained fire resistant framing accessories wherein the fire resistant material is incorporated within the framing accessory itself. As a result, these self-contained fire resistant framing accessories can be used to create fire resistant wall assemblies that do not require separate fire resistant materials that are applied to or attached to a non-fire resistant framing accessory or component of the wall assembly.

In addition, some prior art fire resistant wall assemblies include components that require controlled factory installation of the fire resistant materials, such as those that include a metal header track with a strip of intumescent tape attached thereto, while other prior art fire resistant wall assemblies require multi-step on-site installation by multiple trades. For example, in some prior art wall assemblies that include mineral wool and fire resistant spray or fire caulk, a first trade typically installs the metal framing and a second trade follows up after the framing is installed to install the fire resistant materials. Unlike those prior art fire resistant wall assemblies, some embodiments of the present invention, such as the cap (i.e., framing accessory (310)) described below, provide self-contained fire resistant framing accessories that can be easily installed into a fire resistant wall assembly on-site by the same trade that is installing the framing. As a result, these self-contained fire resistant framing accessories can be used to create fire resistant wall assemblies without requiring controlled factory installation of the fire resistant materials or multiple trades to perform multiple steps on-site to install the fire resistant material into a fire resistant wall assembly.

Additionally, or alternatively to the extrusion process of FIG. 1, a co-extruder (100) can be used to make framing accessories with fire resistant material. FIG. 2 shows a co-extruder (100) that is similar to extruder (10), except that co-extruder (100) comprises two hoppers (12a, 12b) that each feed raw material, which may include fire resistant material or components thereof, into a respective barrel (14a, 14b). A rotating screw (16a, 16b) in each of the respective barrels (14a, 14b) then pushes the material through each barrel (14a, 14b) and into a feeder (18a, 18b) located at the end of each barrel (14a, 14b). Each feeder (18a, 18b) then directs the material into a single die (120), where the two flows of material are shaped into a desired profile. The profile may be configured to allow the framing accessory, and particularly the portion(s) formed of fire resistant material, to expand into an adjacent space when the framing accessory is exposed to an elevated temperature. The resulting framing accessory comprises a body that is formed at least partially of fire resistant material and has the desired profile. In some embodiments substantially the entire body of the framing accessory is formed of fire resistant material. In other embodiments, this process may create a framing accessory with at least two portions, wherein a first portion is formed of fire resistant material (i.e., has material with fire resistant properties) and a second portion is formed of non-fire resistant material (i.e., has material without fire resistant properties). Barrels (14a, 14b) may be heated to melt the material. In the present embodiment, each screw (16a, 16b) is actuated by a respective motor (22a, 22b). Of course, in other embodiments, screws (16a, 16b) could both be actuated by the same motor, instead of each screw (16a, 16b) being actuated by its own motor. Once the material is shaped into a final profile, the framing accessory is cooled. The framing accessory can be cooled with air and/or water with a constant tension puller.

Other suitable methods to make a framing accessory with fire resistant material will be apparent to one with ordinary skill in the art in view of the teachings herein. For instance, while FIG. 2 shows a co-extruder (100) with two extrusion paths, any other suitable number of extrusion paths can be used to make a framing accessory with any suitable number of layers with any suitable combination of fire resistant material and non-fire resistant material. Because fire resistant material may be more expensive than non-fire resistant material, it may be desirable to include fire resistant material in a limited portion or portions of the framing accessory and include non-fire resistant material in the remaining portion or portions of the framing accessory. As discussed above, the fire resistant material may comprise a structural component and a fire resistant component. By way of example only, the fire resistant material may comprise a plastic, including but not limited to PVC, PET or ABS, or an elastomer with intumescent properties. For instance, in some embodiments the plastic or elastomer can include graphite, sodium silicates and other additives. The graphite fibers may provide the desired fire resistivity. In other embodiments, the fire resistant material may comprise a nanocomposite material with fire resistant properties, including but not limited to IntuPlas and/or BernoGraph, which are sold by Pyrophobic Systems Ltd. of Barrie, Ontario, Canada. By way of example only, the fire resistant material may comprise a composition such as the firestop compositions described in US. Patent Publication No. 2012/022201, published Jan. 26, 2012 to Zhvanetskiy et al., which was incorporated by reference above. Other examples of materials that could be used as the fire resistant material or part of the fire resistant material, include but are not limited to: Charmor™, which is sold by Perstorp Holding AB of Malmo, Sweden; Delphi Intumescent Material, which is sold by Delphi Automotive LLC of Gillingham, Kent, United Kingdom; intumescent PVC materials sold by Dugdale Limited of Sowerby Bridge, West Yorkshire, United Kingdom; PVC granules sold by Hangzhou Juntai Plastic Products Co., Ltd. of Hangzhou, Zheijang, China; and FireCarb, which is sold by LKAB Minerals AB of Lulea, Sweden. The non-fire resistant material may comprise any suitable, extrudable material, including but not limited to a plastic, such as PVC, PET or ABS, an elastomer or other suitable polymers. In some embodiments, the non-fire resistant material comprises a thermoset polymer.

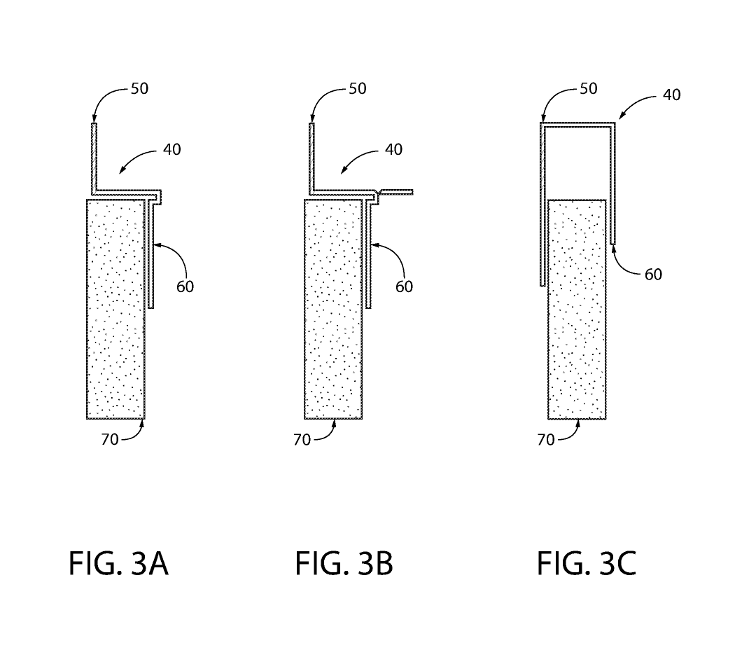

For instance, FIGS. 3A-3C depict various embodiments of a framing accessory (40) positioned on the top of a wallboard panel (70). Wallboard panel (70) may comprise a sheet or panel of drywall, sheetrock, gypsum board, plasterboard or other similar construction materials. Each framing accessory (40) comprises a body comprising a fire resistant portion (50) and a non-fire resistant portion (60) that are formed to create a respective profile. Fire resistant portion (50) may comprise any suitable fire resistant material, including but not limited to a plastic, such as PVC, PET or ABS, or an elastomer with intumescent properties or a nanocomposite material with fire resistant properties, such as IntuPlas and/or BernoGraph, which are sold by Pyrophobic Systems Ltd. of Barrie, Ontario, Canada. By way of example only, fire resistant portion (50) may comprise a composition such as the firestop compositions described in US. Patent Publication No. 2012/022201, published Jan. 26, 2012 to Zhvanetskiy et al., which was incorporated by reference above. As mentioned above, other examples of materials that could be used as the fire resistant material or part of the fire resistant material, include but are not limited to: Charmor™, which is sold by Perstorp Holding AB of Malmo, Sweden; Delphi Intumescent Material, which is sold by Delphi Automotive LLC of Gillingham, Kent, United Kingdom; intumescent PVC materials sold by Dugdale Limited of Sowerby Bridge, West Yorkshire, United Kingdom; PVC granules sold by Hangzhou Juntai Plastic Products Co., Ltd. of Hangzhou, Zheijang, China; and FireCarb, which is sold by LKAB Minerals AB of Lulea, Sweden. In the present embodiment, fire resistant portion (50) is positioned above wallboard panel (70) toward a first surface of wallboard panel (70). Fire resistant portion (50) may be positioned such that, upon heating, the fire resistant portion (50) may expand into an adjacent space and thereby substantially seal the joint along this edge of the wallboard panel (70) to prevent fire from spreading above wallboard panel (70).

Fire resistant portion (50) can be formed, such as by molding, injection molding, extrusion or co-extrusion, separately from non-fire resistant portion (60) and then coupled with non-fire resistant portion (60). For example, in such an embodiment, fire resistant portion (50) could be coupled with non-fire resistant portion (60) using an adhesive, a weld, a mechanical fastener, or any other suitable means or method of attachment. Alternatively, fire resistant portion (50) can be formed with non-fire resistant portion (60), such as by co-extrusion, such that the fire resistant portion (50) and the non-fire resistant portion (60) are integrally connected to form a single, unitary structure. Of course, other suitable configurations for framing accessory (40) will be apparent to one with ordinary skill in the art in view of the teachings herein. For instance, a different portion of framing accessory (40) can include fire resistant portion (50) or the entire framing accessory (40) can include fire resistant material. The location and size of fire resistant portion (50) can vary with each profile of various framing accessories (40).

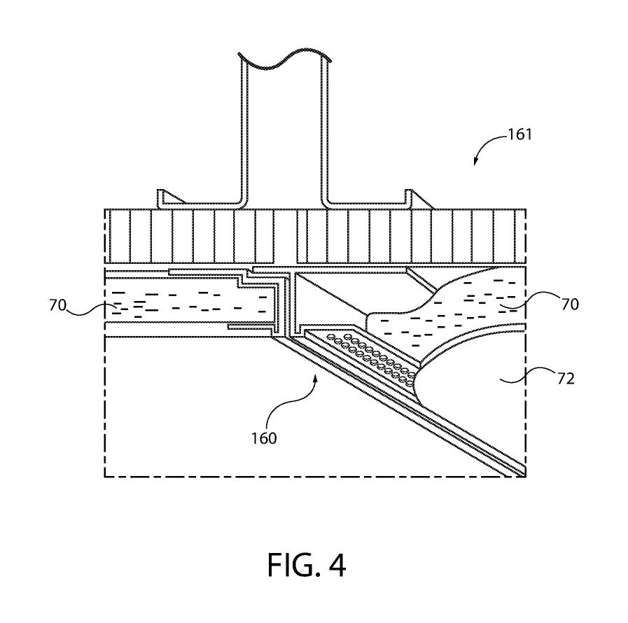

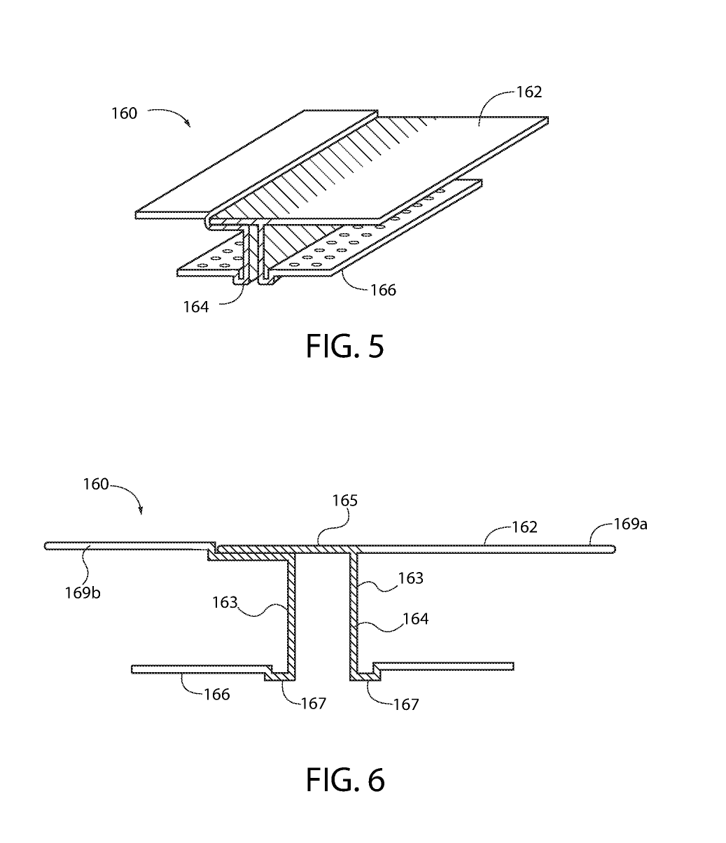

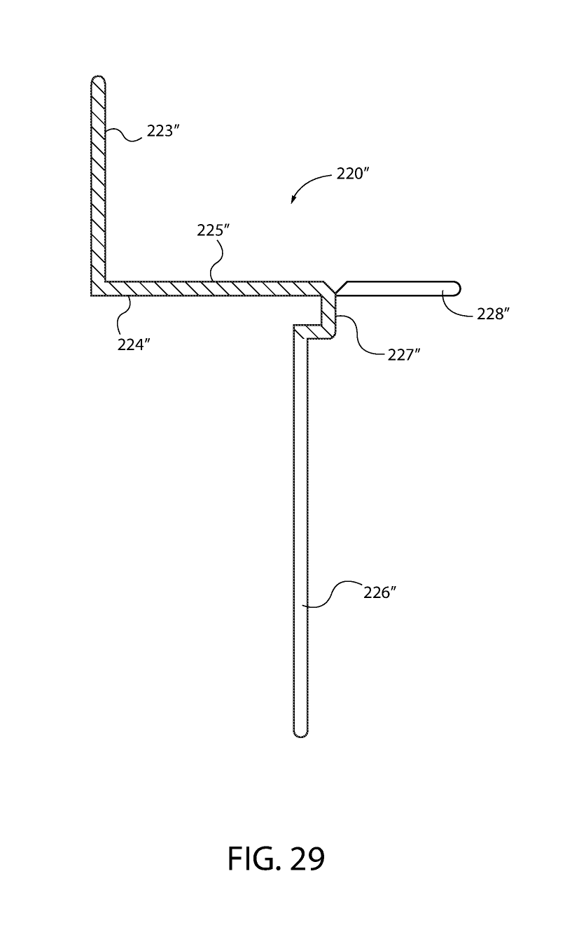

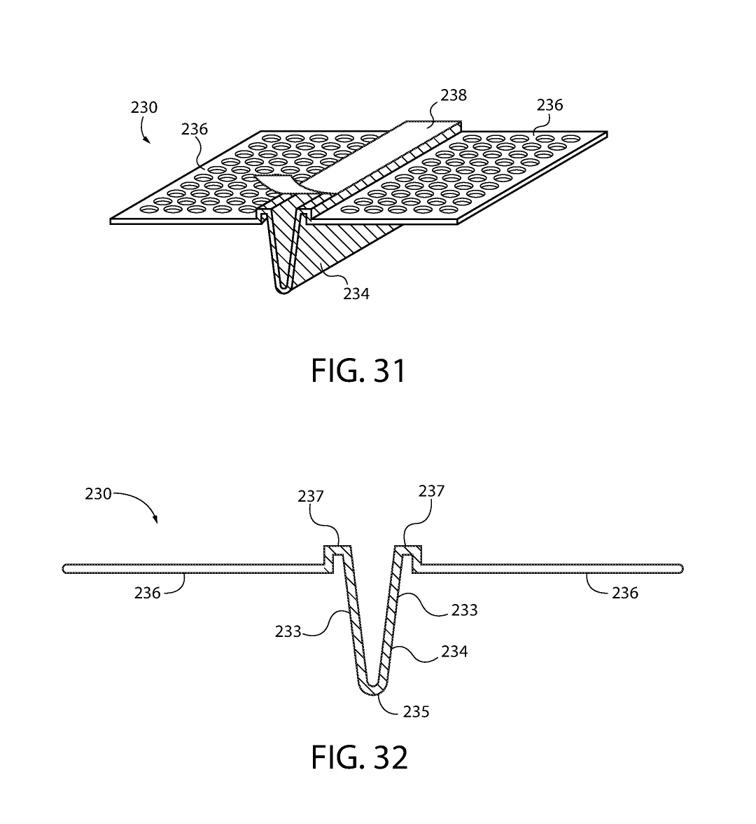

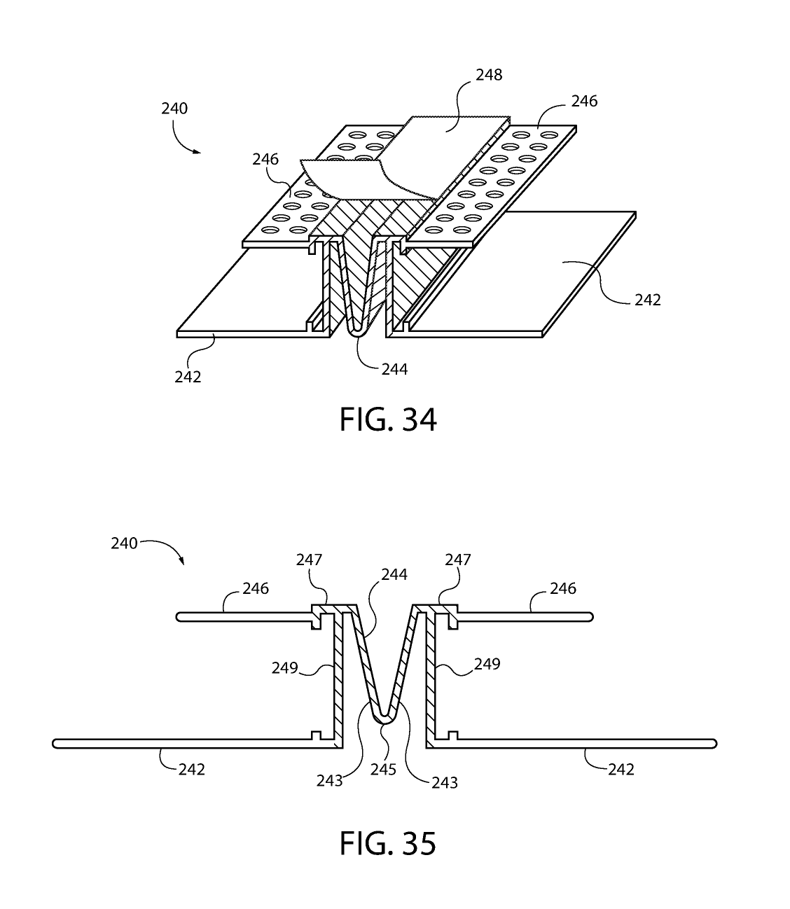

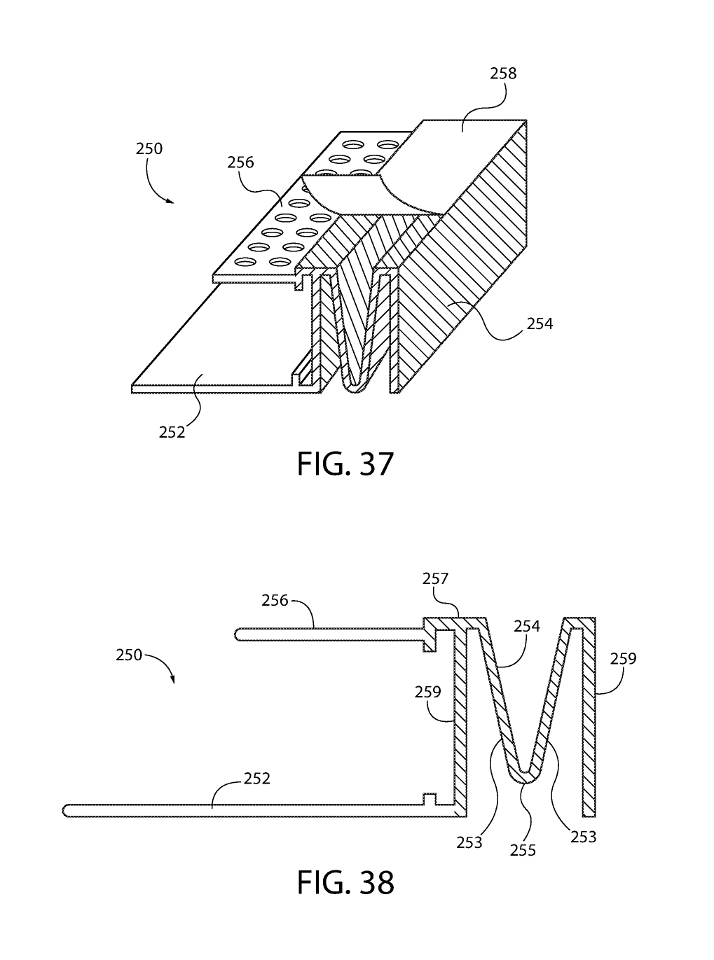

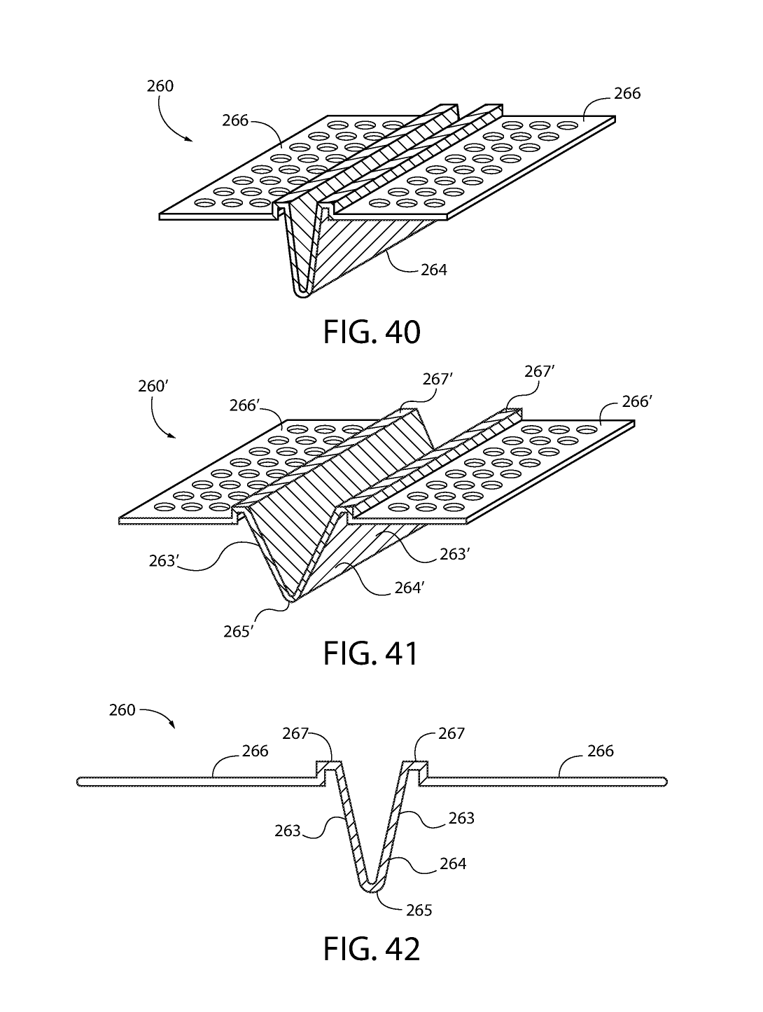

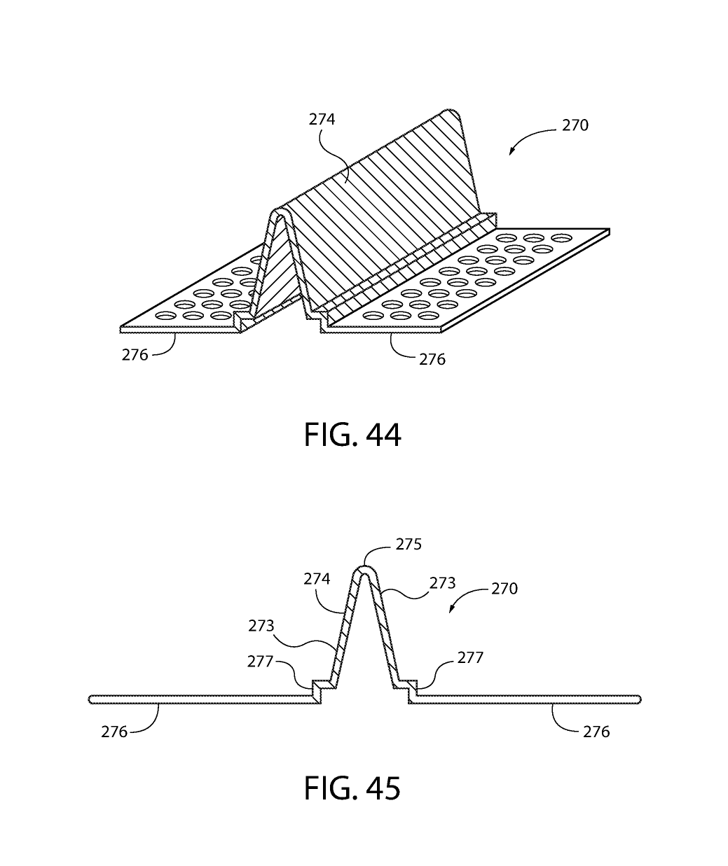

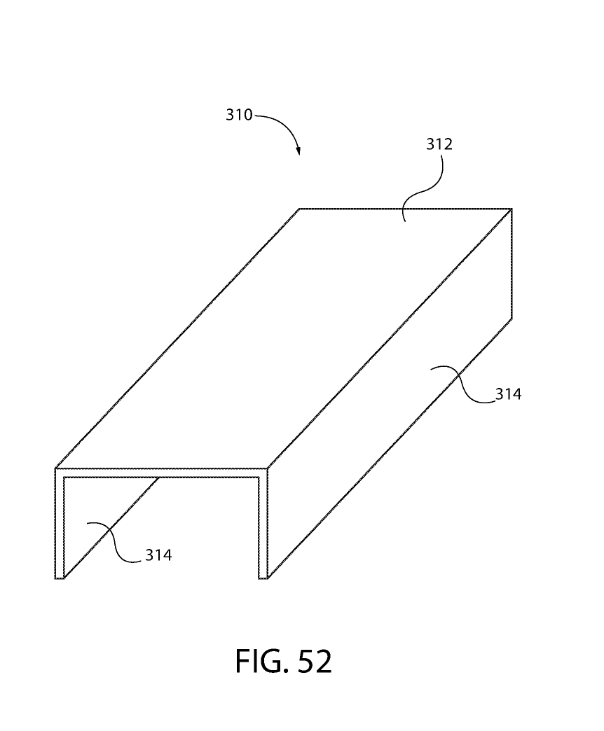

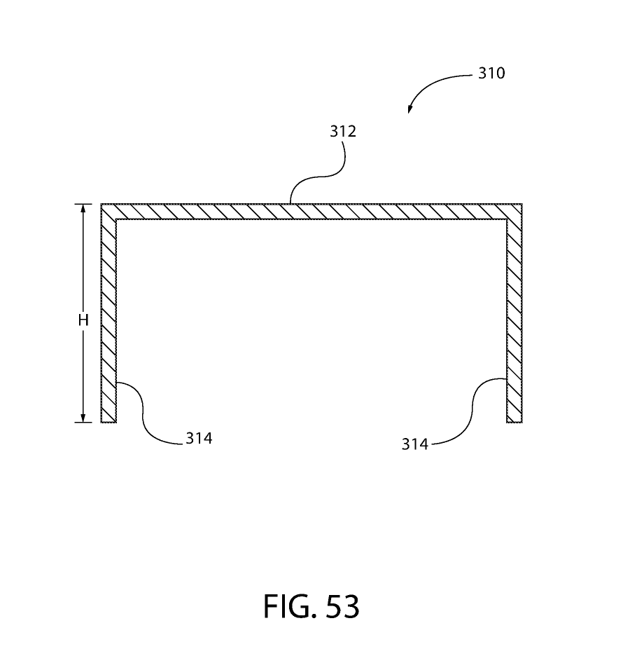

FIGS. 4-54A show various embodiments of framing accessories that include a fire resistant portion. As described above with regard to FIGS. 1-3, each of the framing accessories shown in FIGS. 4-54 may comprise at least one portion that comprises fire resistant material and at least one other portion that comprises non-fire resistant material, or, alternatively, substantially the entire framing accessory may comprise fire resistant material. In addition, as described above, the portion of the framing accessory that comprises fire resistant material and the portion that comprises non-fire resistant material may comprise separate components that are coupled together using any suitable means or method of attachment, including but not limited to an adhesive, a weld, and a mechanical fastener. Alternatively, the portion of the framing accessory that comprises fire resistant material and the portion that comprises non-fire resistant material may be formed together, such as by co-extrusion, such that those portions are integrally connected to form a single, unitary structure.

In particular, FIGS. 4-6 show a framing accessory (160) that is an expansion joint configured to relieve stress and assist in controlling cracking in large areas of wallboard. FIG. 4 depicts a wall assembly (161) that includes framing accessory (160) positioned between two wallboard panels (70). As shown, framing accessory (160) comprises a first piece (169a) and a second piece (169b) configured to mate together to form a body comprising a back portion (162), perforated flanges (166), and a central portion (164) extending between back portion (162) and perforated flanges (166). In the illustrated embodiment, central portion (164) comprises a recess to form a U-shape, but other suitable shapes for central portion (164) can be used. As shown, central portion (164) includes a pair of side walls (163) extending substantially perpendicularly from a base member (165) that extends between the pair of side walls (163). In this embodiment, the base member (165) comprises a section of and is substantially coplanar with back portion (162). In the illustrated embodiment, central portion (164) also includes a pair of lips (167) that extend from a free end of each of the pair of side walls. A portion of the lips (167) may extend in a plane that is substantially perpendicular relative to the side walls (163) and substantially parallel relative to the base member (165), while another portion of the lips (167) may extend in a direction toward back portion (162) in a plane that is substantially parallel to the pair of side walls (163). As shown, each lip (167) is connected to a corresponding perforated flange (166). Back portion (162) is configured to be positioned against a framing member, such as a stud or sheet of plywood (FIG. 4). Each of the wallboard panels (70) is then positioned between back portion (162) and flanges (166) to abut central portion (164). Joint compound or veneer plaster (72) can then be applied over perforated flanges (166) for a flush finish if desired.

In this embodiment, first part (169a) comprises one side wall (163), one lip (167), a section of back portion (162), and a perforated flange (166), while second part (169b) comprises the other side wall (163), the other lip (167), the other section of back portion (162) and the other perforated flange (166). As shown, first part (169a) also comprises base member (165), while second part (169b) comprises a section that rests on base member (165). First part (169a) and second part (169b) may be configured to slide relative to each other to allow for movement at the joint.

In the illustrated embodiment, central portion (164) is made of fire resistant material (indicated by the cross-hatching), while flanges (166) and back portion (162) are made of non-fire resistant material. As illustrated in FIG. 4, at least a portion of the framing accessory (160) that is made of fire resistant material is exposed after framing accessory (160) is installed in wall assembly (161) and wall assembly (161) is fully assembled, while at least a portion of framing accessory (160) that is made of non-fire resistant material is not exposed (i.e., covered by other components of wall assembly (161), such as wallboards (70) and joint compound or veneer plaster (72)) after wall assembly (161) is fully assembled. In other embodiments, various other portions of accessory (160) are made of fire resistant material. For instance, the entire accessory (160) can be made of fire resistant material, flanges (166) and/or back portion (162) can be made of fire resistant material, or a smaller portion of central portion (164) can be made of fire resistant material.

In some embodiments, the fire resistant portion of each part (169a, 169b) of framing accessory (160) can be formed with the non-fire resistant portion, such as by co-extrusion, so that the fire resistant portion and non-fire resistant portion of each part (169a, 169b) are integrally connected to form a single unitary structure. In other embodiments where the entire framing accessory (160) (i.e., all of first part (169a) and all of second part (169b) is made or formed of fire resistant material, each part (169a, 169b) can be extruded or co-extruded utilizing fire resistant material. Alternatively, the fire resistant portion of each part (169a, 169b) of accessory (160) can be extruded or co-extruded and subsequently assembled with the non-fire resistant portion of each part (169a, 169b) of accessory (160) using one or more of mechanical fasteners, adhesives, welding or any other suitable method or means of attachment. The body of framing accessory (160) may comprise a profile configured to allow the body, and particularly the portion(s) formed of fire resistant material, to expand into an adjacent space when the body is exposed to an elevated temperature. Still other suitable configurations for accessory (160) will be apparent to one with ordinary skill in the art in view of the teachings herein.

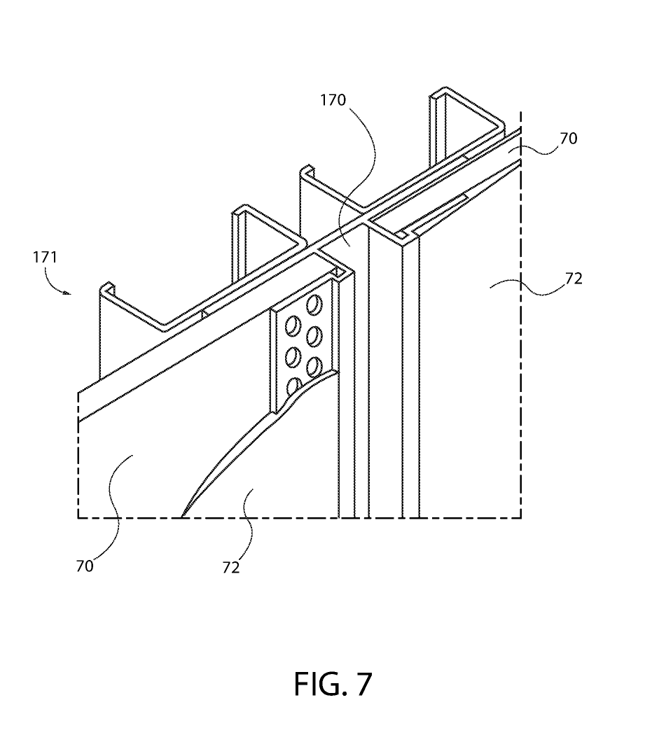

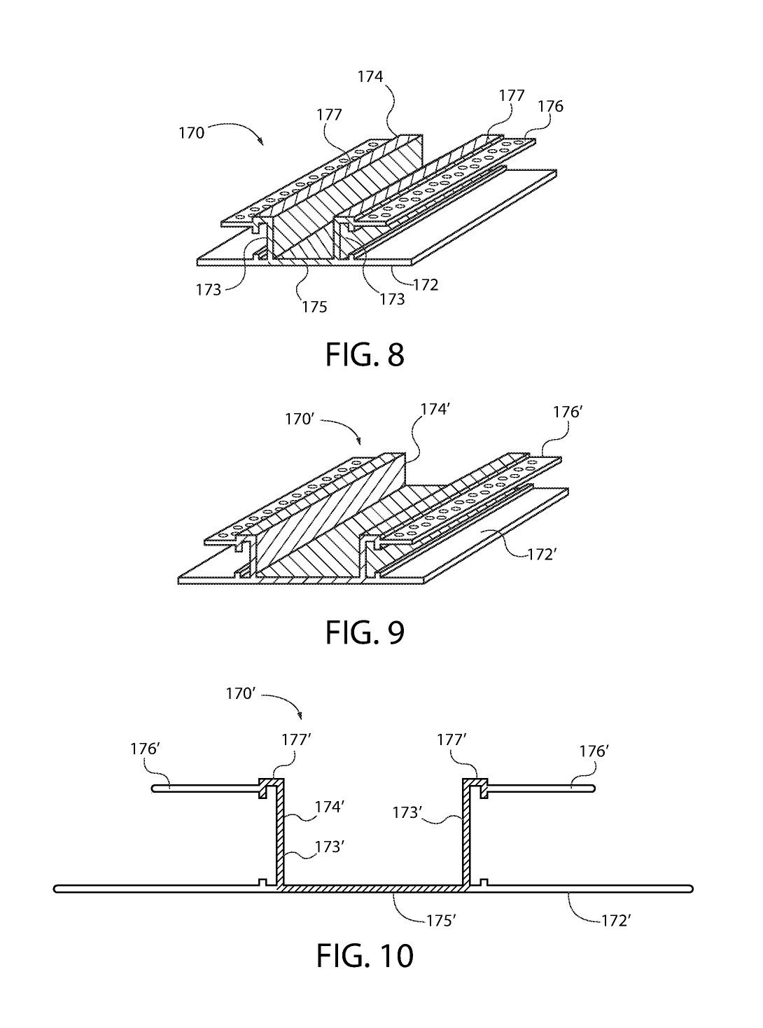

FIGS. 7-8 show another framing accessory (170) that is a channel reveal configured to be positioned between two wallboard panels (70) to create a reveal in the wallboard. FIG. 7 depicts a wall assembly (171) that includes framing accessory (170) positioned between two wallboard panels (70). FIGS. 9-10 depict an alternate embodiment of a framing accessory (170′) with a larger reveal compared to the embodiment shown in FIGS. 7-8 (i.e., framing accessory (170)). Framing accessory (170′) is substantially identical to framing accessory (170), except that the reveal in framing accessory (170′) has a larger width than the reveal in framing accessory (170).

As shown, framing accessory (170, 170′) comprises a body comprising a back portion (172, 172′), perforated flanges (176, 176′), and a central portion (174, 174′) extending between back portion (172, 172′) and perforated flanges (176, 176′). In the illustrated embodiment, central portion (174, 174′) comprises a recess to form a U-shape, but other suitable shapes for central portion (174, 174′) can be used. As shown, central portion (174, 174′) includes a pair of side walls (173, 173′) extending substantially perpendicularly from a base member (175, 175′) that extends between the pair of side walls (173, 173′). In this embodiment, the base member (175, 175′) comprises a section of and is substantially coplanar with back portion (172, 172′). In the illustrated embodiment, central portion (174, 174′) also includes a pair of lips (177, 177′) that extend from a free end of each of the pair of side walls (173, 173′). A portion of the lips (177, 177′) may extend in a plane that is substantially perpendicular relative to the side walls (173, 173′) and substantially parallel relative to back portion (172, 172′), while another portion of the lips (177, 177′) may extend in a direction toward back portion (172, 172′) in a plane that is substantially parallel to the pair of side walls (173, 173′). As shown, each lip (177, 177′) is connected to a corresponding perforated flange (176, 176′).

Back portion (172, 172′) is configured to be positioned against a framing member, such as a stud (FIG. 7). Each of the wallboard panels (70) is then positioned between back portion (172, 172′) and flanges (176, 176′) to abut central portion (174, 174′). Central portion (174, 174′) can vary in width to create different sized reveals in the wallboard. For example, the width of central portion (174, 174′) can be between about ½ inch and about 3 inches. After the wallboard panels (70) are positioned within framing accessory (170, 170′), joint compound or veneer plaster (72) can then be applied over perforated flanges (176, 176′) for a flush finish if desired.

In the illustrated embodiments, central portion (174, 174′) is made of fire resistant material (indicated by the cross-hatching), while flanges (176, 176′) and back portion (172, 172′) are made of non-fire resistant material. As illustrated in FIG. 7, in this embodiment, the portion of framing accessory (170, 170′) that is exposed after it is installed in wall assembly (171) and wall assembly (171) is fully assembled is made of fire resistant material, while the remaining portions of framing accessory (170, 170′) (i.e., the portions that are not exposed or are covered by other components of the wall assembly (171) after wall assembly (171) is fully assembled) are made of non-fire resistant material. In other embodiments, various other portions of accessory (170, 170′) are made of fire resistant material. For instance, the entire accessory (170, 170′) can be made of fire resistant material, flanges (176, 176′) and/or back portion (172, 172′) can be made of fire resistant material, or a smaller portion of central portion (174, 174′) can be made of fire resistant material. In some embodiments, the fire resistant portion of framing accessory (170, 170′) can be formed with the non-fire resistant portion, such as by co-extrusion, so that the fire resistant portion and non-fire resistant portion are integrally connected to form a single unitary structure. In other embodiments where the entire framing accessory (170, 170′) is made of fire resistant material, the entire accessory can be extruded or co-extruded utilizing fire resistant material. Alternatively, the fire resistant portion of accessory (170, 170′) can be extruded or co-extruded and subsequently assembled with the non-fire resistant portion of accessory (170, 170′) using one or more of mechanical fasteners, adhesives, welding or any other suitable method or means of connection. The body of framing accessory (170, 170′) may comprise a profile configured to allow the body, and particularly the portion(s) formed of fire resistant material, to expand into an adjacent space when the body is exposed to an elevated temperature. Still other suitable configurations for accessory (170, 170′) will be apparent to one with ordinary skill in the art in view of the teachings herein.

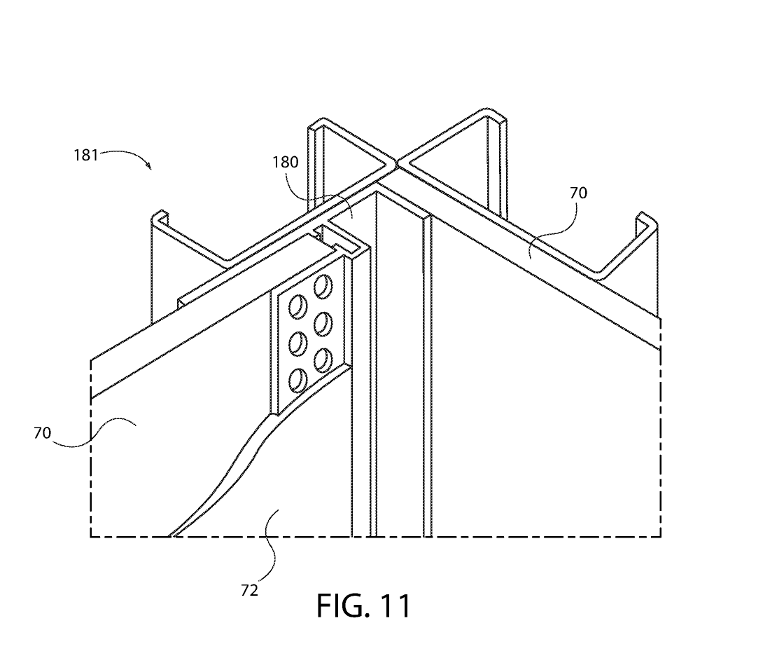

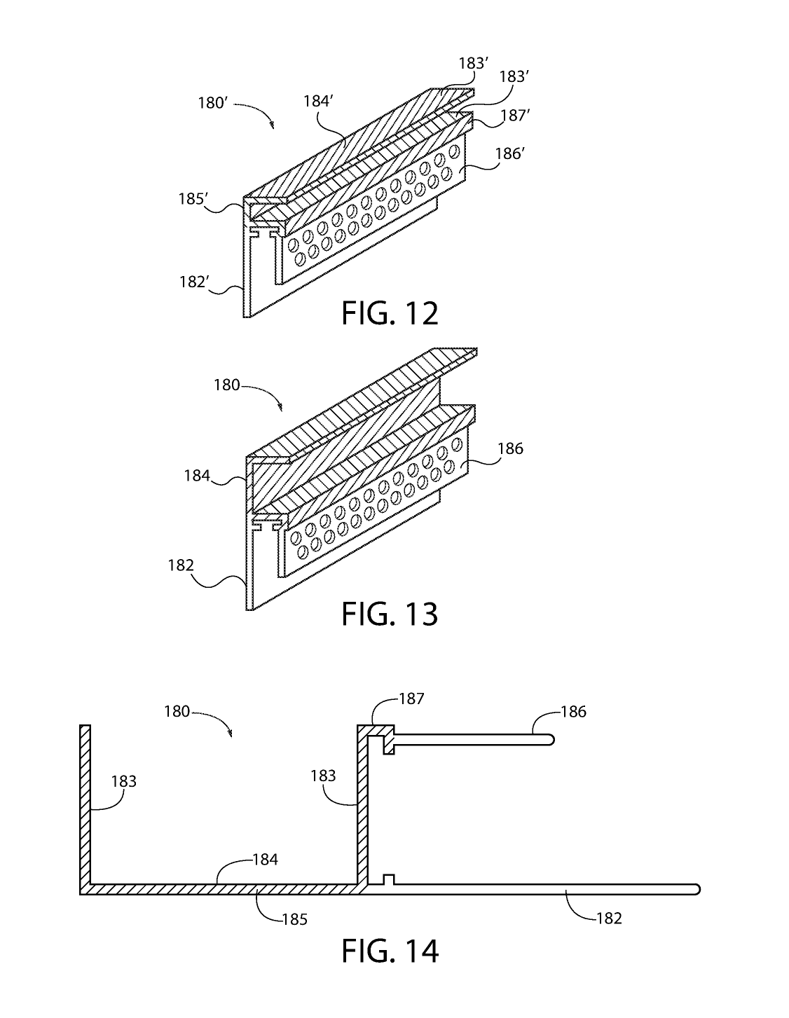

FIGS. 11, 13 and 14 show another framing accessory (180) that is a channel reveal configured to be positioned in a corner between two wallboard panels (70) to create a reveal in the wallboard. FIG. 11 depicts a wall assembly (181) that includes framing accessory (180) positioned in a corner between two wallboard panels (70). FIG. 12 depicts an alternate embodiment of a framing accessory (180′) with a smaller reveal compared to the embodiment shown in FIGS. 11, 13, and 14 (i.e., framing accessory (180). Framing accessory (180′) is substantially identical to framing accessory (180), except that the reveal in framing accessory (180′) formed by central portion (184′) has a smaller width than the reveal in framing accessory (180) formed by central portion (184).

As shown, framing accessory (180, 180′) comprises a body comprising a back portion (182, 182′), a perforated flange (186, 186′), and a central portion (184, 184′) extending between back portion (182, 182′) and perforated flange (186, 186′). In the illustrated embodiment, central portion (184, 184′) comprises a recess to form a U-shape, but other suitable shapes for central portion (184, 184′) can be used. As shown, central portion (184, 184′) includes a pair of side walls (183, 183′) extending substantially perpendicularly from a base member (185, 185′) that extends between the pair of side walls (183, 183′). In this embodiment, the base member (185, 185′) comprises a section of and is substantially co-planar with back portion (182, 182′). In the illustrated embodiment, central portion (184, 184′) also includes a lip (187, 187′) that extends from a free end of one of the pair of side walls (183, 183′). A portion of the lip (187, 187′) may extend in a plane that is substantially perpendicular relative to the side walls (183, 183′) and substantially parallel relative to the base member (185, 185′), while another portion of the lip (187, 187′) may extend in a direction toward back portion (182, 182′) in a plane that is substantially parallel to the pair of side walls (183, 183′). As shown, the lip (187, 187′) is connected to perforated flange (186, 186′).

Back portion (182, 182′) is configured to be positioned against a framing member, such as a stud (FIG. 11). A first wallboard panel (70) is then positioned between back portion (182, 182′) and flange (186, 186′) to abut central portion (184, 184′), and a second wallboard panel (70) is positioned to abut the opposing side of central portion (184, 184′). Central portion (184, 184′) can vary in width to create different sized reveals in the wallboard. For example, the width of central portion (184, 184′) can be between about ½ inch and about 3 inches. After the respective wallboard panels (70) are positioned within framing accessory (180, 180′), joint compound or veneer plaster (72) can then be applied over perforated flange (186, 186′) for a flush finish if desired.

In the illustrated embodiment, central portion (184, 184′) is made of fire resistant material (indicated by the cross-hatching), while flange (186, 186′) and back portion (182, 182′) are made of non-fire resistant material. As illustrated in FIG. 11, in this embodiment, the portion of framing accessory (180, 180′) that is exposed after it is installed in wall assembly (181) and wall assembly (181) is fully assembled is made of fire resistant material, while the remaining portions of framing accessory (180, 180′) (i.e., the portions that are not exposed or are covered by other components of the wall assembly (181) after wall assembly (181) is fully assembled) are made of non-fire resistant material. In other embodiments, various other portions of accessory (180, 180′) are made of fire resistant material. For instance, the entire accessory (180, 180′) can be made of fire resistant material, flange (186, 186′) and/or back portion (182, 182′) can be made of fire resistant material, or a smaller portion of central portion (184, 184′) can be made of fire resistant material. In some embodiments, the fire resistant portion of framing accessory (180, 180′) can be formed with the non-fire resistant portion, such as by co-extrusion, so that the fire resistant portion and non-fire resistant portion are integrally connected to form a single unitary structure. In other embodiments where the entire framing accessory (180, 180′) is made of fire resistant material, the entire accessory can be extruded or co-extruded utilizing fire resistant material. Alternatively, the fire resistant portion of accessory (180, 180′) can be extruded or co-extruded and subsequently assembled with the non-fire resistant portion of accessory (180, 180′) using one or more of mechanical fasteners, adhesives, welding or any other suitable method or means of attachment. The body of framing accessory (180, 180′) may comprise a profile configured to allow the body, and particularly the portion(s) formed of fire resistant material, to expand into an adjacent space when the body is exposed to an elevated temperature. Still other suitable configurations for accessory (180, 180′) will be apparent to one with ordinary skill in the art in view of the teachings herein.

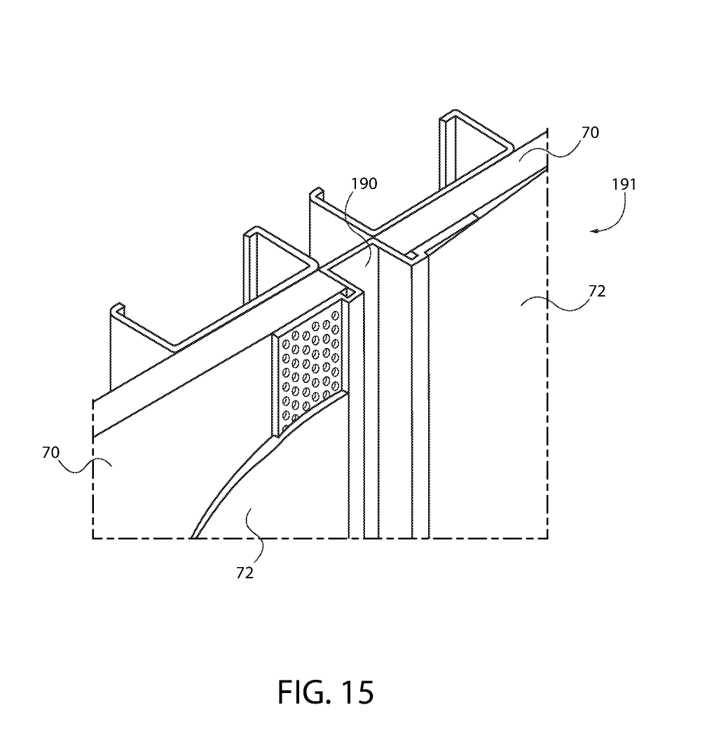

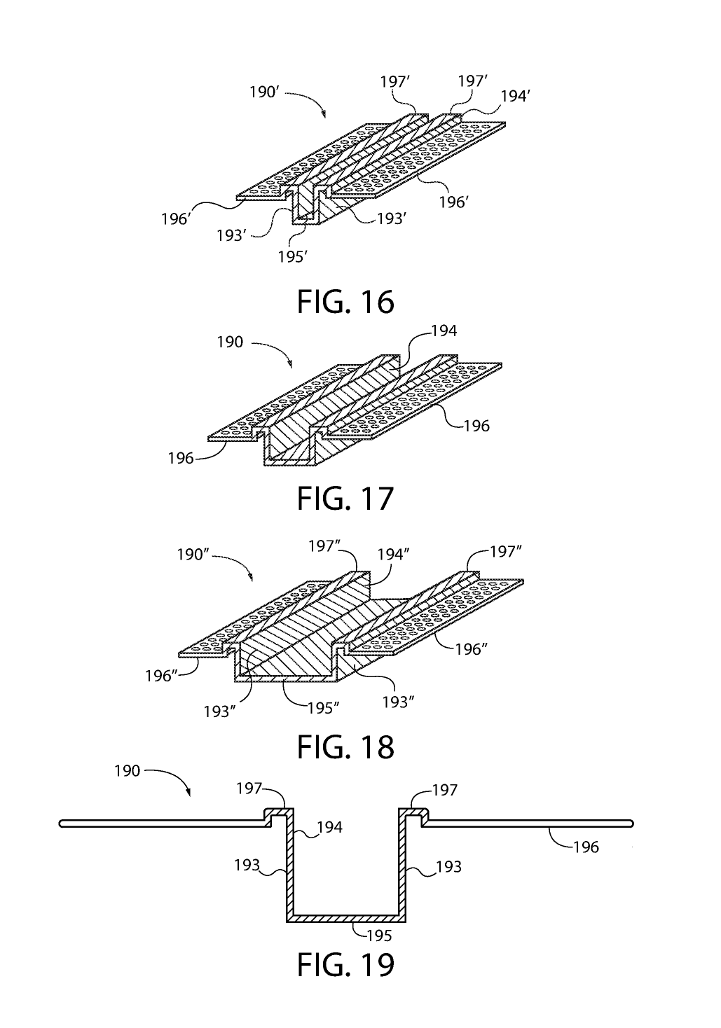

FIGS. 15, 17 and 19 show another embodiment of a framing accessory (190) that is a channel reveal configured to be positioned between two wallboard panels (70) to create a reveal in the wallboard. FIG. 15 depicts a wall assembly (191) that includes framing accessory (190) positioned between two wallboard panels (70). FIGS. 16 and 18 depict alternate embodiments of a framing accessory (190′, 190″) with varying sizes of reveals. The embodiment shown in FIG. 16 (i.e., framing accessory (190′) is substantially identical to the embodiments shown in FIGS. 15 and 17-19 (i.e., framing accessory (190, 190″), except that the reveal has a smaller width in framing accessory (190′). Similarly, the embodiment shown in FIG. 18 (i.e., framing accessory (190″) is substantially identical to the embodiments shown in FIGS. 15-17 and 19 (i.e., framing accessory (190, 190′)), except that the reveal has a larger width in framing accessory (190″).

As shown, framing accessory (190, 190′, 190″) comprises a body comprising a pair of perforated flanges (196, 196′, 196″) and a central portion (194, 194′, 194″) extending between perforated flanges (196, 196′, 196″). In the illustrated embodiment, central portion (194, 194′, 194″) comprises a recess to form a U-shape, but other suitable shapes for central portion (194, 194′, 194″) can be used. As shown, central portion (194, 194′, 194″) includes a pair of side walls (193, 193′, 193″) extending substantially perpendicularly from a base member (195, 195′, 195″) that extends between the pair of side walls (193, 193′, 193″). In the illustrated embodiment, central portion (194, 194′, 194″) also includes a pair of lips (197, 197′, 197″) that extend from a free end of each of the pair of side walls (193, 193′, 193″). A portion of each lip (197, 197′, 197″) may extend in a plane that is substantially perpendicular relative to the side walls (193, 193′, 193″) and substantially parallel relative to the base member (195, 195′, 195″), while another portion of each lip (197, 197′, 197″) may extend in a direction toward the base member (195, 195′, 195″) in a plane that is substantially parallel to the pair of side walls (193, 193′, 193″). As shown, each lip (197, 197′, 197″) is connected to a corresponding perforated flange (196, 196′, 196″).

Central portion (194, 194′, 194″) of accessory (190, 190′, 190″) is positioned between two wallboard panels (70) such that flanges (196, 196′, 196″) are positioned over each wallboard panel (70) (FIG. 15). Central portion (194, 194′, 194″) can vary in width to create different sized reveals in the wallboard. For example, the width of central portion (194, 194′, 194″) can be between about ¼ inch and about 2 inches. This can be used at a juncture of dissimilar materials. After the wallboard panels (70) are positioned within framing accessory (190, 190′, 190″), joint compound or veneer plaster (72) can then be applied over perforated flanges (196, 196′, 196″) for a flush finish if desired.

In the illustrated embodiment, central portion (194, 194′, 194″) is made of fire resistant material (indicated by the cross-hatching), while flanges (196, 196′, 196″) are made of non-fire resistant material. As illustrated in FIG. 15, in this embodiment, the portion of framing accessory (190, 190′, 190″) that is exposed after it is installed in wall assembly (191) and wall assembly (191) is fully assembled is made of fire resistant material, while the remaining portions of framing accessory (190, 190′, 190″) (i.e., the portions that are not exposed or are covered by other components of the wall assembly (191) after wall assembly (191) is fully assembled) are made of non-fire resistant material. In other embodiments, various other portions of accessory (190, 190′, 190″) are made of fire resistant material. For instance, the entire accessory (190, 190′, 190″) can be made of fire resistant material, only one of the flanges (196, 196′, 196″) can be made of fire resistant material, or a smaller portion of central portion (194, 194′, 194″) can be made of fire resistant material. In some embodiments, the fire resistant portion of framing accessory (190, 190′, 190″) can be formed with the non-fire resistant portion, such as by co-extrusion, so that the fire resistant portion and non-fire resistant portion are integrally connected to form a single unitary structure. In other embodiments where the entire framing accessory (190, 190′, 190″) is made of fire resistant material, the entire accessory can be extruded or co-extruded utilizing fire resistant material. Alternatively, the fire resistant portion of accessory (190, 190′, 190″) can be extruded or co-extruded and subsequently assembled with the non-fire resistant portion of accessory (190, 190′, 190″) using one or more of mechanical fasteners, adhesives, welding or any other suitable method or means of attachment. The body of framing accessory (190, 190′, 190″) may comprise a profile configured to allow the body, and particularly the portion(s) formed of fire resistant material, to expand into an adjacent space when the body is exposed to an elevated temperature. Still other suitable configurations for accessory (190, 190′, 190″) will be apparent to one with ordinary skill in the art in view of the teachings herein.

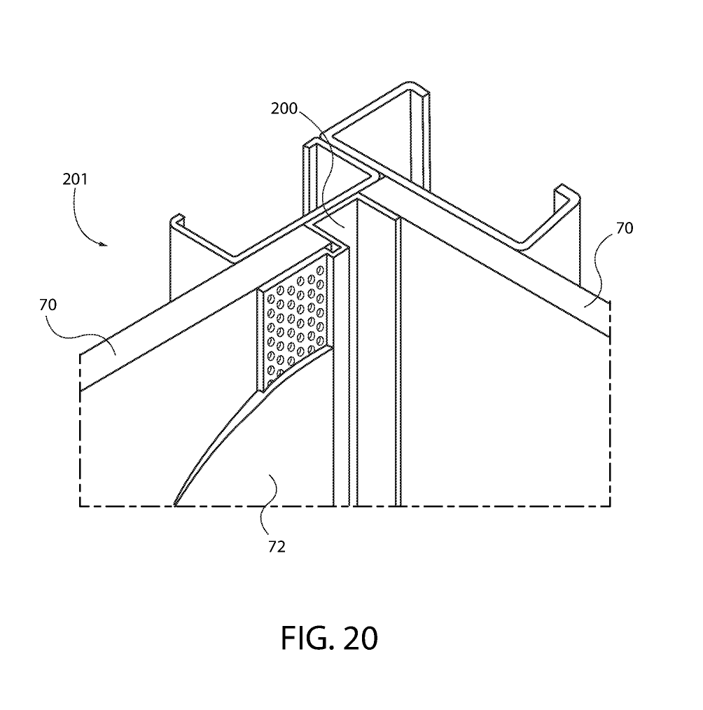

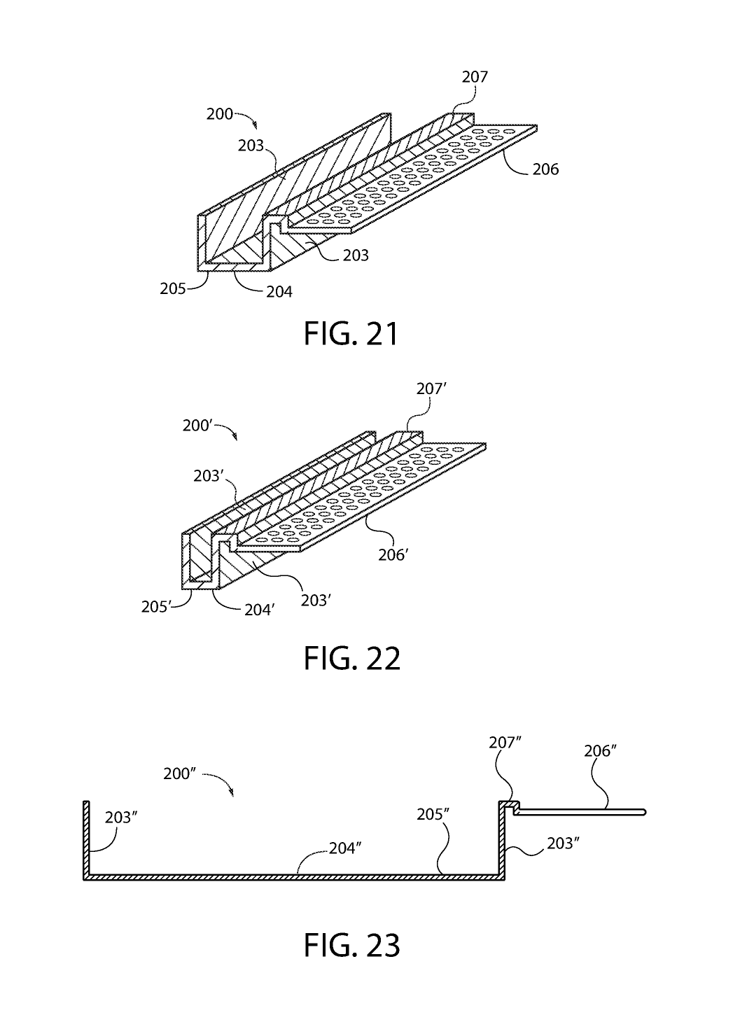

FIGS. 20-21 show another embodiment of a framing accessory (200) that is a channel reveal configured to be positioned in a corner between two wallboard panels (70) to create a reveal in the wallboard. FIG. 20 depicts a wall assembly (201) that includes framing accessory (200) positioned in a corner between two wallboard panels (70). FIGS. 22 and 23 depict alternate embodiments of a framing accessory (200′, 200″) with varying sizes of reveals. Framing accessory (200′) is substantially identical to the embodiments shown in FIGS. 20, 21 and 23 (i.e., framing accessory (200, 200″)), except that the reveal has a smaller width in framing accessory (200′). Similarly, framing accessory (200″) is substantially identical to embodiments shown in FIGS. 20-22 (i.e., framing accessory (200, 200′)), except that the reveal has a larger width in framing accessory (200″).

As shown, framing accessory (200, 200′, 200″) comprises a body comprising a perforated flange (206, 206′, 206″) and a central portion (204, 204′, 204″) extending outwardly from flange (206, 206′, 206″). In the illustrated embodiment, central portion (204, 204′, 204″) comprises a recess to form a U-shape, but other suitable shapes for central portion (204, 204′, 204″) can be used. As shown, central portion (204, 204′, 204″) includes a pair of side walls (203, 203′, 203″) extending substantially perpendicularly from a base member (205, 205′, 205″) that extends between the pair of side walls (203, 203′, 203″). In the illustrated embodiment, central portion (204, 204′, 204″) also includes a lip (207, 207′, 207″) that extends from a free end of one of the pair of side walls (203, 203′, 203″). A portion of the lip (207, 207′, 207″) may extend in a plane that is substantially perpendicular relative to side walls (203, 203′, 203″) and substantially parallel relative to the base member (205, 205′, 205″), while another portion of the lip (207, 207′, 207″) may extend in a direction toward the base member (205, 205′, 205″) in a plane that is substantially parallel to the pair of side walls (203, 203′, 203″). As shown, the lip (207, 207′, 207″) is connected to perforated flange (206, 206′, 206″).

Central portion (204, 204′, 204″) of accessory (200, 200′, 200″) is positioned between two wallboard panels (70) such that flange (206, 206′, 206″) is positioned over a first wallboard (70) and an opposing side of central portion (204, 204′, 204″) abuts a second wallboard panel (70) (FIG. 20). Central portion (204, 204′, 204″) can vary in width to create different sized reveals in the wallboard. For example, the width of central portion (204, 204′, 204″) can be between about ¼ inch and about 1 inch. This can be used at a juncture of dissimilar materials. After the wallboard panel (70) is positioned within framing accessory (200, 200′, 200″), joint compound or veneer plaster (72) can then be applied over perforated flange (206, 206′, 206″) for a flush finish if desired.

In the illustrated embodiments, central portion (204, 204′, 204″) is made of fire resistant material (indicated by the cross-hatching), while flange (206, 206′, 206″) is made of non-fire resistant material. As illustrated in FIG. 20, in this embodiment, the portion of framing accessory (200, 200′, 200″) that is exposed after it is installed in wall assembly (201) and wall assembly (201) is fully assembled is made of fire resistant material, while the remaining portions of framing accessory (200, 200′, 200″) (i.e., the portions that are not exposed or are covered by other components of the wall assembly (201) after wall assembly (201) is fully assembled) are made of non-fire resistant material. In other embodiments, various other portions of accessory (200, 200′, 200″) are made of fire resistant material. For instance, the entire accessory (200, 200′, 200″) can be made of fire resistant material, flange (206, 206′, 206″) can be made of fire resistant material, or a smaller portion of central portion (204, 204′, 204″) can be made of fire resistant material.

In some embodiments, the fire resistant portion of framing accessory (200, 200′, 200″) can be formed with the non-fire resistant portion, such as by co-extrusion, so that the fire resistant portion and non-fire resistant portion are integrally connected to form a single unitary structure. In other embodiments where the entire framing accessory (200, 200′, 200″) is made of fire resistant material, the entire accessory can be extruded or co-extruded utilizing fire resistant material. Alternatively, the fire resistant portion of accessory (200, 200′, 200″) can be extruded or co-extruded and subsequently assembled with the non-fire resistant portion of accessory (200, 200′, 200″) using one or more of mechanical fasteners, adhesives, welding or any other suitable method or means of attachment. The body of framing accessory (200, 200″) may comprise a profile configured to allow the body, and particularly the portion(s) formed of fire resistant material, to expand into an adjacent space when the body is exposed to an elevated temperature. Still other suitable configurations for accessory (200, 200′, 200″) will be apparent to one with ordinary skill in the art in view of the teachings herein.

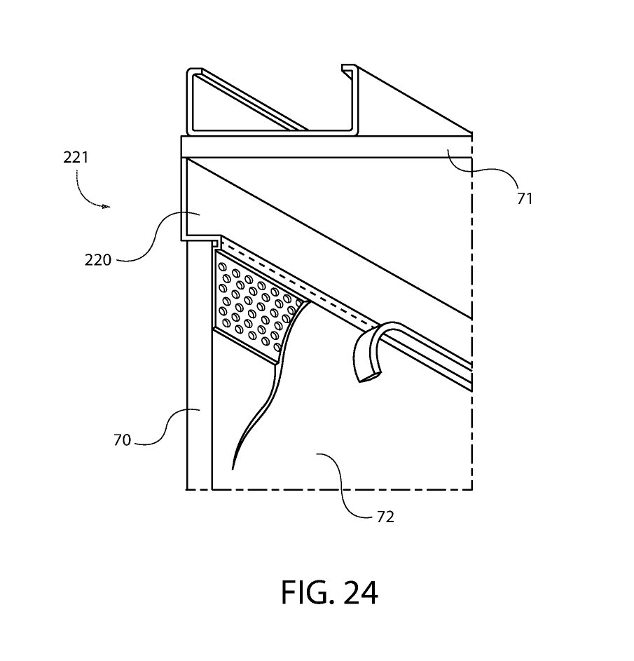

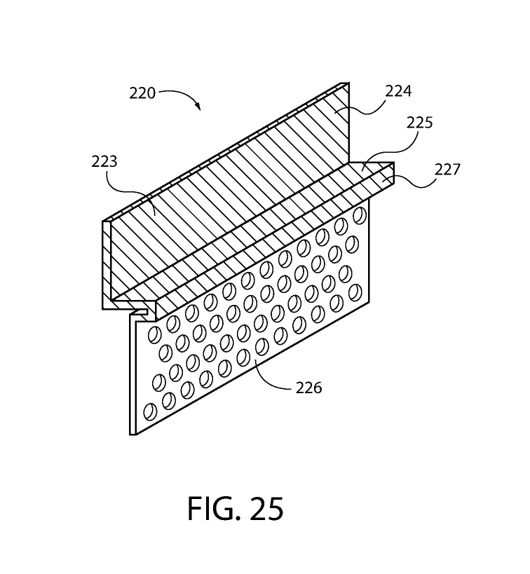

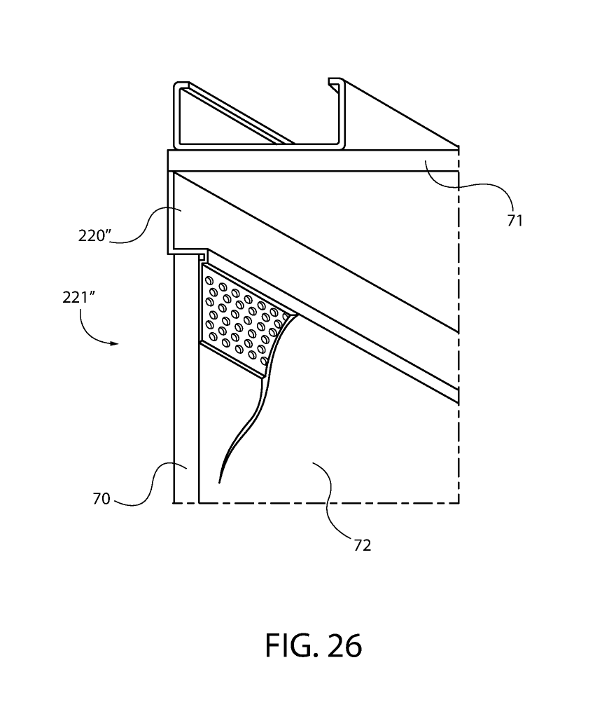

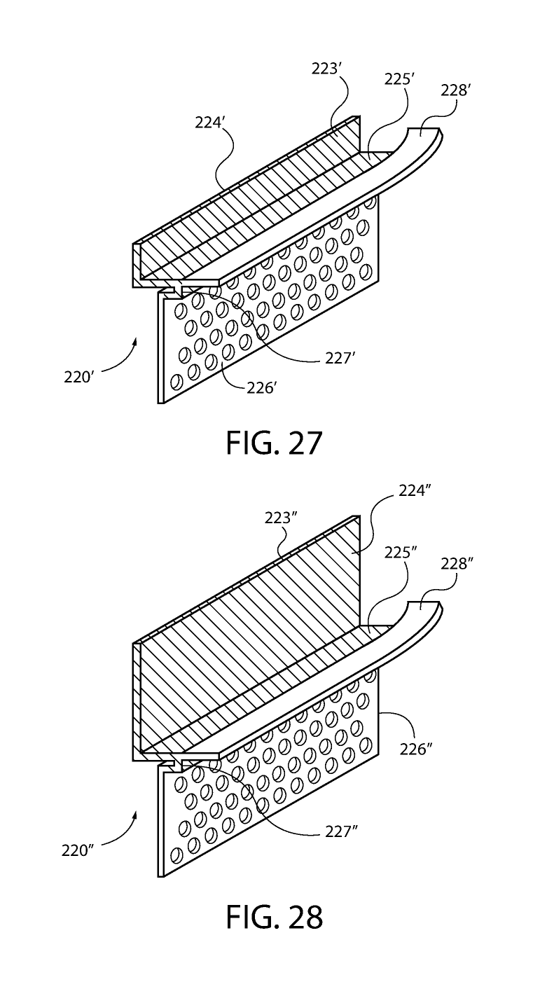

FIGS. 24-25 show another embodiment of a framing accessory (220) that is a shadow reveal configured to be positioned in a corner between a wall and a ceiling. FIG. 24 depicts a wall assembly (221) that includes framing accessory (220) positioned in a corner between a wallboard panel (70) and ceiling (71). FIGS. 26-29 depict alternate embodiments of a framing accessory (220′, 200″) with a removable leg (228′, 228″) and varying sizes of reveal members. FIG. 26 depicts a wall assembly (221″) that includes framing accessory (220″) positioned in a corner between a wallboard panel (70) and ceiling (71). The embodiment shown in FIGS. 26, 28 and 29 (i.e., framing accessory (220″)) is substantially identical to the embodiment shown in FIGS. 24-25 (i.e., framing accessory (220)), except that framing accessory (220″) includes a removable leg (228″) attached to central portion (224″), while framing accessory (220) does not include a removable leg. The embodiment shown in FIG. 27 (i.e., framing accessory (220′)) is substantially identical to the embodiment shown in FIGS. 26, 28 and 29 (i.e., framing accessory (220″)), except that the reveal member has a smaller height in framing accessory 220′. As shown, framing accessory (220, 220′, 220″) comprises a perforated flange (226, 226′, 226″) and a central portion (224, 224′, 224″) extending outwardly from perforated flange (226, 226′, 226″).

In the illustrated embodiment, central portion (224, 224′, 224″) comprises a body comprising a base member (225, 225′, 225″) and a reveal member (223, 223′, 223″) extending substantially perpendicular to the base member (225, 225′, 225″). In this embodiment, the base member (225, 225′, 225″) extends in a plane that is substantially perpendicular relative to perforated flange (226, 226′, 226″) and reveal member (223, 223′, 223″) extends in a plane that is substantially parallel relative to perforated flange (226, 226′, 226″). As shown, the base member (225, 225′, 225″) comprises a J-profile that includes a flange and a lip (227, 227′, 227″) that extends from one end of the flange of the base member (225, 225′, 225″). A portion of the lip (227, 227′, 227″) may extend in a plane that is substantially perpendicular relative to the flange of the base member (225, 225′, 225″) and substantially parallel relative to perforated flange (226, 226′, 226″) and reveal member (223, 223′, 223″), while another portion of the lip (227, 227′, 227″) may extend in a direction toward the reveal member (223, 223′, 223″) in a plane that is substantially parallel relative to the flange of the base member (225, 225′, 225″). As shown, in framing accessory (220′, 220″) removable leg (218′, 218″) is removably coupled to the portion of the lip (227′, 227″) that extends in a plane that is substantially perpendicular relative to the flange of the base member (225′, 225″) and substantially parallel relative to perforated flange (226′, 226″) and reveal member (223′, 223″). In framing accessory (220, 220′, 220″) perforated flange (226, 226′, 226″) is connected to the portion of the lip (227, 227′, 227″) that extends in a direction toward reveal member (223, 223′, 223″) in a plane that is substantially parallel to the flange of the base member (225, 225′, 225″).

In the embodiments shown in FIGS. 26-29, framing accessory (220′, 220″) further comprises an optional removable leg (228′, 228″) removably coupled with central portion (224′, 224″). As shown in FIGS. 24 and 26, the reveal member of central portion (224, 224′, 224″) is positioned against a ceiling (71) and flange (226, 226′, 226″) is positioned over a wallboard panel (70). This can cover raw edges of a wallboard panel. The reveal member of central portion (224, 224′, 224″) can vary in height to accommodate reveals of different sizes. For instance, the reveal member can range from about 3/16 of an inch to about 1 inch. Framing accessory (220′, 220″), and particularly leg (228′, 228″) may be configured to prevent staining of a ceiling, window frame, or other dissimilar material positioned adjacent to framing accessory (220′, 220″). For example, leg (228′, 228″) may remain attached to central portion (224′, 224″) while wallboard panel (70) is being finished (e.g., painted, plastered, etc.) so that excess finishing material may be applied to leg (228′, 228″) instead of onto the ceiling (71), window frame or other dissimilar material. After the finishing of wallboard panel (70) is completed, then leg (228′, 228″) can be removed to provide a clean finish to the joint between wallboard panel (70), framing accessory (220′, 220″) and the ceiling (71), window frame or dissimilar material. After the wallboard panel (70) is positioned within framing accessory (220, 220′, 220″), joint compound or veneer plaster (72) can then be applied over perforated flange (226, 226′, 226″) for a flush finish if desired.

In the illustrated embodiments, central portion (224, 224′, 224″) is made of fire resistant material (indicated by the cross-hatching), while perforated flange (226, 226′, 226″) (and in some embodiments, removable leg (228′, 228″)) is made of non-fire resistant material. As illustrated in FIGS. 24 and 26, in these embodiments, the portion of framing accessory (220, 220′, 220″) that is exposed after it is installed in wall assembly (221, 221″) and wall assembly (221, 221″) is fully assembled is made of fire resistant material, while the remaining portions of framing accessory (220, 220′, 220″) (i.e., the portions that are not exposed or are covered by other components of the wall assembly (221, 221″) after wall assembly (221, 221″) is fully assembled) are made of non-fire resistant material. In other embodiments, various other portions of accessory (220, 220′, 220″) are made of fire resistant material. For instance, the entire accessory (220, 220′, 220″) can be made of fire resistant material, flange (226, 226′, 226″) can be made of fire resistant material, or a smaller portion of central portion (224, 224′, 224″) can be made of fire resistant material.

In some embodiments, the fire resistant portion of framing accessory (220, 220′, 220″) can be formed with the non-fire resistant portion, such as by co-extrusion, so that the fire resistant portion and non-fire resistant portion are integrally connected to form a single unitary structure. In other embodiments where the entire framing accessory (220, 220′, 220″) is made of fire resistant material, the entire accessory can be extruded or co-extruded utilizing fire resistant material. Alternatively, the fire resistant portion of accessory (220, 220′, 220″) can be extruded or co-extruded and subsequently assembled with the non-fire resistant portion of accessory (220, 220′, 220″) using one or more of mechanical fasteners, adhesives, welding or any other suitable method or means of attachment. The body of framing accessory (220, 220′, 220″) may comprise a profile configured to allow the body, and particularly the portion(s) formed of fire resistant material, to expand into an adjacent space when the body is exposed to an elevated temperature. Still other suitable configurations for accessory (220, 220′, 220″) will be apparent to one with ordinary skill in the art in view of the teachings herein.

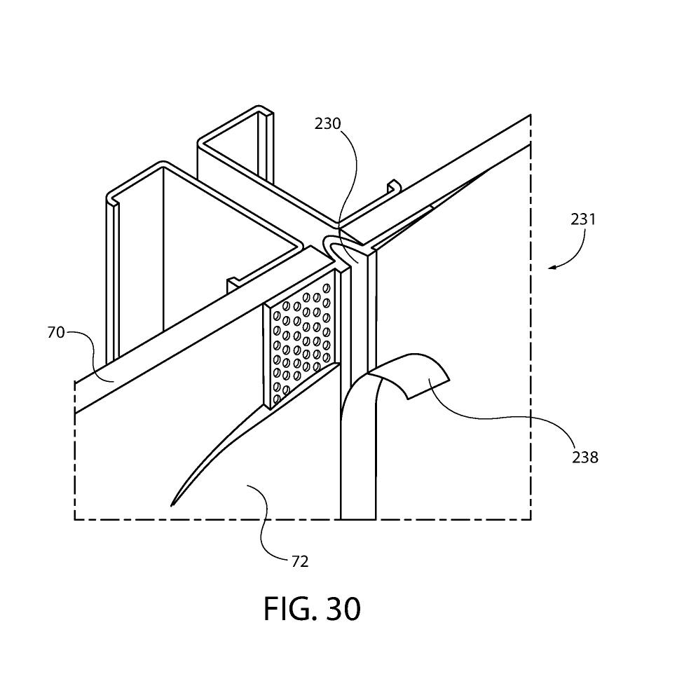

FIGS. 30-32 show another embodiment of a framing accessory (230) that is a control joint configured to provide stress relief and assist in controlling cracking in large areas of wallboard. FIG. 30 depicts a wall assembly (231) that includes framing accessory (230) positioned between two wallboard panels (70). As shown, framing accessory (230) comprises a body comprising a pair of perforated flanges (236) and a central portion (234) extending between flanges (236). A piece of removable tape (238) may be initially positioned over the recess of central portion (234). In the illustrated embodiment, central portion (234) comprises a V-shape, but other suitable shapes for central portion (234) can be used. As shown, central portion (234) includes a pair of angled side walls (233) connected by a curved base member (235). In the illustrated embodiment, central portion (234) also includes a pair of lips (237) that extend from a free end of each of the pair of side walls (233). A portion of each lip (237) may extend in a plane that is substantially parallel relative to perforated flanges (236), while another portion of each lip (237) may extend in a direction toward base member (235) in a plane that is substantially perpendicular relative to perforated flanges (236). As shown, each lip (237) is connected to a corresponding perforated flange (236).

As shown, central portion (234) of accessory (230) is positioned between two wallboard panels (70) such that flanges (236) are positioned over each wallboard panel (70) (FIG. 30). Framing accessory (230) and removable tape (238) may be configured to prevent staining of the central portion (234). For example, tape (238) may remain attached to central portion (234) while one or both of the wallboard panels (70) is being finished (e.g., painted, plastered, etc.) so that excess finishing material may be applied to tape (238) instead of onto central portion (234). After the finishing of wallboard panels (70) is completed, then tape (238) can be removed to provide a clean finish to the joint between wallboard panels (70). After the wallboard panels (70) are positioned within framing accessory (230), joint compound or veneer plaster (72) can then be applied over perforated flange (236) for a flush finish if desired.

In the illustrated embodiment, central portion (234) is made of fire resistant material (indicated by the cross-hatching), while flanges (236) are made of non-fire resistant material. As illustrated in FIG. 30, in this embodiment, the portion of framing accessory (230) that is exposed after it is installed in wall assembly (231) and wall assembly (231) is fully assembled is made of fire resistant material, while the remaining portions of framing accessory (230) (i.e., the portions that are not exposed or are covered by other components of the wall assembly (231) after wall assembly (231) is fully assembled) are made of non-fire resistant material. In other embodiments, various other portions of accessory (230) are made of fire resistant material. For instance, the entire accessory (230) can be made of fire resistant material, one or both of the flanges (236) can be made of fire resistant material, or a smaller portion of central portion (234) can be made of fire resistant material.

In some embodiments, the fire resistant portion of framing accessory (230) can be formed with the non-fire resistant portion, such as by co-extrusion, so that the fire resistant portion and non-fire resistant portion are integrally connected to form a single unitary structure. In other embodiments where the entire framing accessory (230) is made of fire resistant material, the entire accessory can be extruded or co-extruded utilizing fire resistant material. Alternatively, the fire resistant portion of accessory (230) can be extruded or co-extruded and subsequently assembled with the non-fire resistant portion of accessory (230) using one or more of mechanical fasteners, adhesives, welding or any other suitable method or means of attachment. The body of framing accessory (230) may comprise a profile configured to allow the body, and particularly the portion(s) formed of fire resistant material, to expand into an adjacent space when the body is exposed to an elevated temperature. Still other suitable configurations for accessory (230) will be apparent to one with ordinary skill in the art in view of the teachings herein.

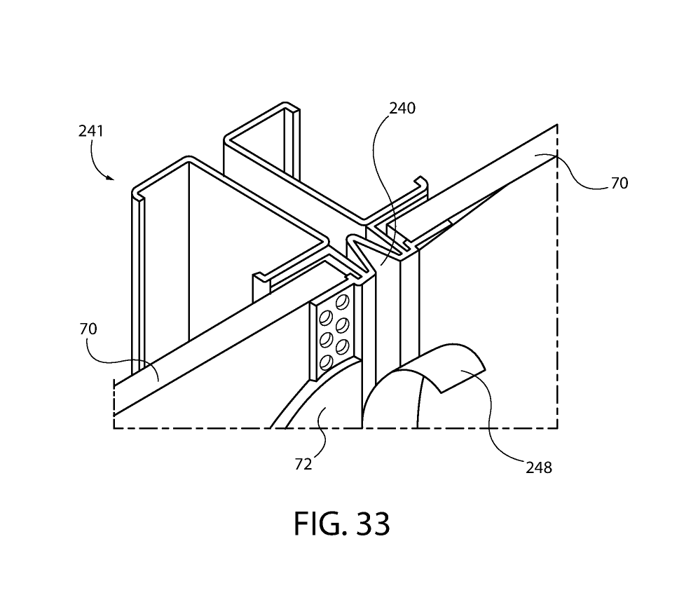

FIGS. 33-35 show another embodiment of a framing accessory (240) that is a control joint configured to provide stress relief and assist in controlling cracking in large areas of wallboard. FIG. 33 depicts a wall assembly (241) that includes framing accessory (240) positioned between two wallboard panels (70). As shown, framing accessory (240) comprises a body comprising a back portion (242), a pair of perforated flanges (246), and a central portion (244) extending between back portion (242) and flanges (246). A piece of removable tape (248) is initially positioned over the recess of central portion (244). In the illustrated embodiment, central portion (244) comprises a M-shape, but other suitable shapes for central portion (244), including but not limited to a V-shape, can be used. As shown, central portion (244) includes a pair of vertical side walls (249) connected to a pair of angled side walls (243) that extend between the pair of vertical side walls (249). The angled side walls (243) are connected to each other by a curved base member (245). The vertical side walls (249) extend in a plane that is substantially perpendicular relative to back portion (242) and perforated flanges (246). In the illustrated embodiment, central portion (244) also includes a pair of lips (247) that extend from an upper end of each of the pair of vertical side walls. (249). A portion of each lip (247) may extend in a plane that is substantially parallel relative to perforated flanges (246), while another portion of each lip (247) may extend in a direction toward back portion (242) in a plane that is substantially perpendicular relative to perforated flanges (246) and substantially parallel relative to the vertical side walls (249). As shown, each lip (247) is connected to a corresponding perforated flange (246).

As shown, back portion (242) is positioned against a framing member, such as a stud and central portion (244) of accessory (240) is positioned between two wallboard panels (70) such that wallboard panels (70) are received between corresponding ones of perforated flanges (246) and back portion (242). Framing accessory (240) and removable tape (248) may be configured to prevent staining of the central portion (244). For example, tape (248) may remain attached to central portion (244) while one or both of the wallboard panels (70) is being finished (e.g., painted, plastered, etc.) so that excess finishing material may be applied to tape (248) instead of onto central portion (244). After the finishing of wallboard panels (70) is completed, then tape (248) can be removed to provide a clean finish to the joint between wallboard panels (70). After the wallboard panels (70) are positioned within framing accessory (240), joint compound or veneer plaster (72) can then be applied over perforated flange (246) for a flush finish if desired.

In the illustrated embodiment, central portion (244) is made of fire resistant material (indicated by the cross-hatching), while back portion (242) and flanges (246) are made of non-fire resistant material. As illustrated in FIG. 33, at least a portion of the framing accessory (240) that is made of fire resistant material is exposed after framing accessory (240) is installed in wall assembly (241) and wall assembly (241) is fully assembled, while at least a portion of framing accessory (240) that is made of non-fire resistant material is not exposed (i.e., covered by other components of wall assembly (241), such as joint compound or veneer plaster (72)) after wall assembly (241) is fully assembled. In other embodiments, various other portions of accessory (240) are made of fire resistant material. For instance, the entire accessory (240) can be made of fire resistant material, back portion (242) and/or flanges (246) can be made of fire resistant material, or a smaller portion of central portion (244) can be made of fire resistant material.

In some embodiments, the fire resistant portion of framing accessory (240) can be formed with the non-fire resistant portion, such as by co-extrusion, so that the fire resistant portion and non-fire resistant portion are integrally connected to form a single unitary structure. In other embodiments where the entire framing accessory (240) is made of fire resistant material, the entire accessory can be extruded or co-extruded utilizing fire resistant material. Alternatively, the fire resistant portion of accessory (240) can be extruded or co-extruded and subsequently assembled with the non-fire resistant portion of accessory (240) using one or more of mechanical fasteners, adhesives, welding or any other suitable method or means of attachment. The body of framing accessory (240) may comprise a profile configured to allow the body, and particularly the portion(s) formed of fire resistant material, to expand into an adjacent space when the body is exposed to an elevated temperature. Still other suitable configurations for accessory (240) will be apparent to one with ordinary skill in the art in view of the teachings herein.

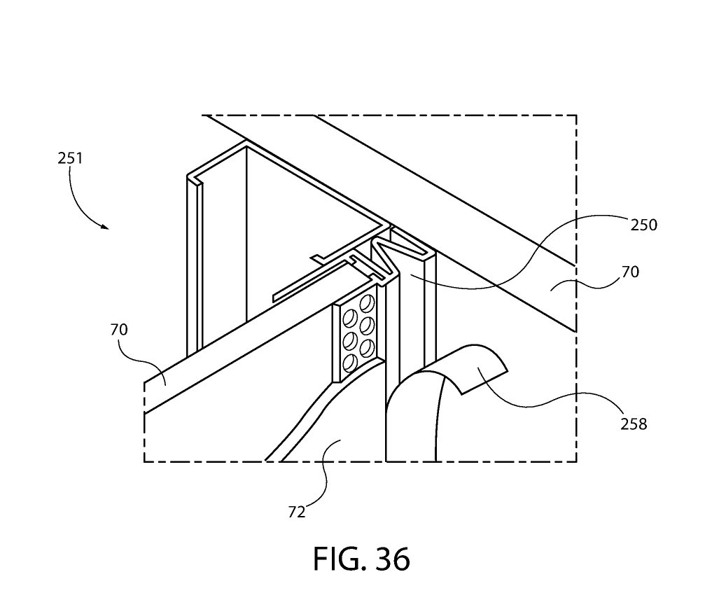

FIGS. 36-38 show another embodiment of a framing accessory (250) that is similar to framing accessory (240) that is a control joint configured to provide stress relief at the junction of walls, ceilings, floor lines, or dissimilar materials. FIG. 36 depicts a wall assembly (251) that includes framing accessory (250) positioned in a corner or intersection between two wallboard panels (70). As shown, framing accessory (250) comprises a body comprising a back portion (252), a perforated flange (256), and a central portion (254) extending between back portion (252) and perforated flange (256). A piece of removable tape (258) is initially positioned over the recess of central portion (254). In the illustrated embodiment, central portion (254) comprises a M-shape, but other suitable shapes for central portion (254), including but not limited to a V-shape, can be used. As shown, central portion (254) includes a pair of vertical side walls (259) connected to a pair of angled side walls (253) that extend between the pair of vertical side walls (259). The angled side walls (253) are connected to each other by a curved base member (255). The vertical side walls (259) extend in a plane that is substantially perpendicular relative to back portion (252) and perforated flange (256). In the illustrated embodiment, central portion (254) also includes a lip (257) that extends from an upper end of one of the pair of vertical side walls (259). A portion of the lip (257) may extend in a plane that is substantially parallel relative to perforated flange (256), while another portion of the lip (257) may extend in a direction toward back portion (252) in a plane that is substantially perpendicular relative to the perforated flanges (256) and substantially parallel relative to the vertical side walls (259). As shown, the lip (257) is connected to perforated flange (256).

As shown, central portion (254) of accessory (250) is positioned between two wallboard panels (70) such that one of wallboard panel (70) is received between perforated flange (256) and back portion (252) and central portion (250) abuts a surface of the other wallboard panel (70). Back portion (252) may be positioned against a framing member, such as a stud. Framing accessory (250) and removable tape (258) may be configured to prevent staining of the central portion (254). For example, tape (258) may remain attached to central portion (254) while one or both of the wallboard panels (70) is being finished (e.g., painted, plastered, etc.) so that excess finishing material may be applied to tape (258) instead of onto central portion (254). After the finishing of wallboard panels (70) is completed, then tape (258) can be removed to provide a clean finish to the joint between wallboard panels (70). After the wallboard panel (70) is positioned within framing accessory (250), joint compound or veneer plaster (72) can then be applied over perforated flange (256) for a flush finish if desired.

In the illustrated embodiment, central portion (254) is made of fire resistant material (indicated by the cross-hatching), while back portion (252) and flange (256) are made of non-fire resistant material. As illustrated in FIG. 36, at least a portion of the framing accessory (250) that is made of fire resistant material is exposed after framing accessory (250) is installed in wall assembly (251) and wall assembly (251) is fully assembled, while at least a portion of framing accessory (250) that is made of non-fire resistant material is not exposed (i.e., covered by other components of wall assembly (251), such as joint compound or veneer plaster (72)) after wall assembly (251) is fully assembled. In other embodiments, various other portions of accessory (250) are made of fire resistant material. For instance, the entire accessory (250) can be made of fire resistant material, back portion (252) and/or flange (256) can be made of fire resistant material, or a smaller portion of central portion (254) can be made of fire resistant material.

In some embodiments, the fire resistant portion of framing accessory (250) can be formed with the non-fire resistant portion, such as by co-extrusion, so that the fire resistant portion and non-fire resistant portion are integrally connected to form a single unitary structure. In other embodiments where the entire framing accessory (250) is made of fire resistant material, the entire accessory can be extruded or co-extruded utilizing fire resistant material. Alternatively, the fire resistant portion of accessory (250) can be extruded or co-extruded and subsequently assembled with the non-fire resistant portion of accessory (250) using one or more of mechanical fasteners, adhesives, welding or any other suitable method or means of attachment. The body of framing accessory (250) may comprise a profile configured to allow the body, and particularly the portion(s) formed of fire resistant material, to expand into an adjacent space when the body is exposed to an elevated temperature. Still other suitable configurations for accessory (250) will be apparent to one with ordinary skill in the art in view of the teachings herein.

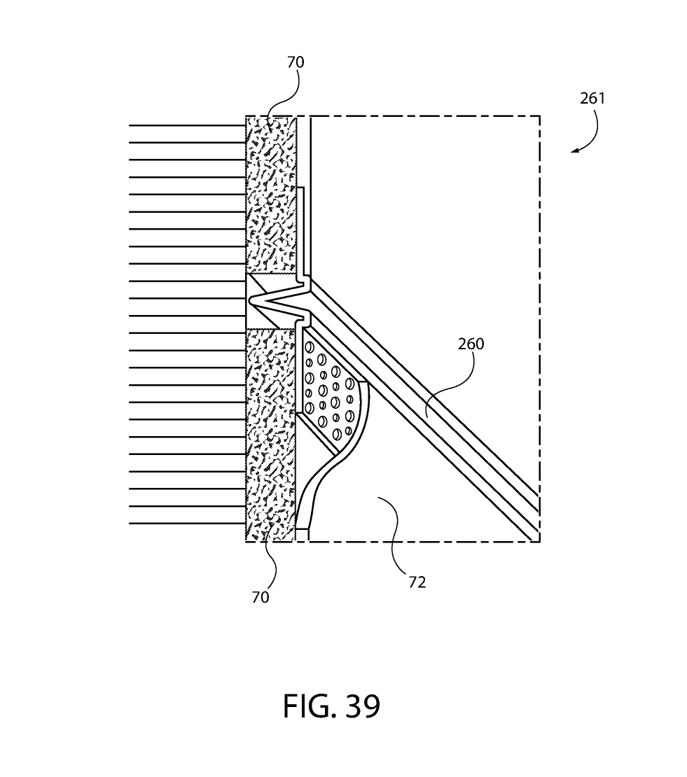

FIGS. 39-40 and 42 show another embodiment of a framing accessory (260) that is a reveal control joint configured to provide stress relief and assist in controlling cracking in large areas of wallboard. FIG. 39 depicts a wall assembly (261) that includes framing accessory (260) positioned between two wallboard panels (70). FIG. 41 depicts an alternate embodiment of a framing accessory (260′) with a larger reveal compared to the embodiment shown in FIGS. 39-40 and 45 (i.e., framing accessory (260)). Framing accessory (260′) is substantially identical to framing accessory (260), except that the reveal has a larger width in framing accessory (260′). As shown, framing accessory (260, 260′) comprises a body comprising a pair of perforated flanges (266, 266′) and a central portion (264, 264′) extending between flanges (266, 266′). Central portion (264, 264′) can vary in width to create different sized reveals in the wallboard. In the illustrated embodiment, central portion (264, 264′) comprises a recess to form a V-shape, but other suitable shapes for central portion (264, 264′) can be used. As shown, central portion (264, 264′) includes a pair of angled side walls (263, 263′) connected by a curved base member (265, 265′). In the illustrated embodiment, central portion (264, 264′) also includes a pair of lips (267, 267′) that extend from a free end of each of the pair of side walls (263, 263′). A portion of each lip (267, 267′) may extend in a plane that is substantially parallel relative to perforated flanges (266, 266′), while another portion of each lip (267, 267′) may extend in a direction toward the base member (235, 235′) in a plane that is substantially perpendicular relative to perforated flanges (266, 266′). As shown, each lip (267, 267′) is connected to a corresponding perforated flange (266, 266′).

As shown, central portion (264, 264′) of accessory (260, 260′) is positioned between two wallboard panels (70) such that flanges (266, 266′) are positioned over each wallboard panel (70) (FIG. 39). After the wallboard panels (70) are positioned within framing accessory (260, 260′), joint compound or veneer plaster (72) can then be applied over perforated flanges (266, 266′) for a flush finish if desired.

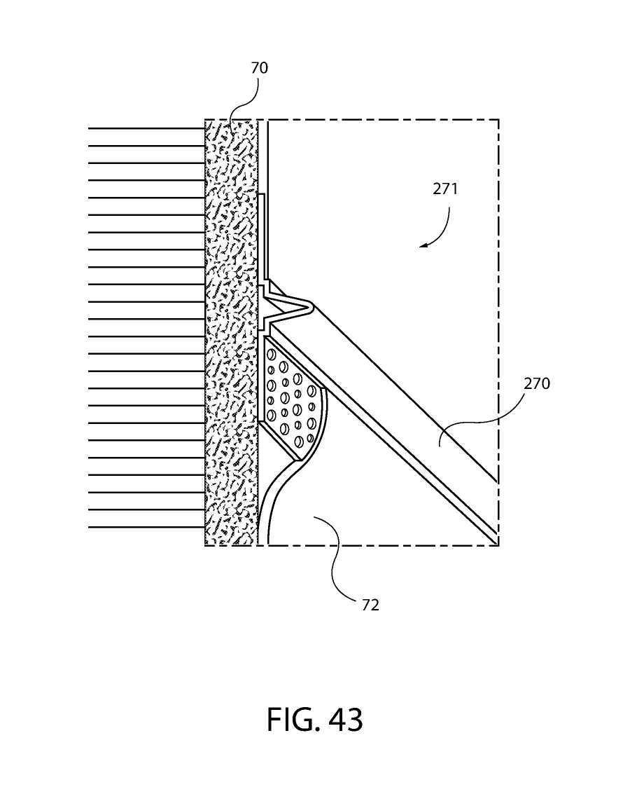

In the illustrated embodiment, central portion (264, 264′) is made of fire resistant material (indicated by the cross-hatching), while flanges (266, 266′) are made of non-fire resistant material. As illustrated in FIG. 43, in this embodiment, the portion of framing accessory (260, 260′) that is exposed after it is installed in wall assembly (261) and wall assembly (261) is fully assembled is made of fire resistant material, while the remaining portions of framing accessory (260, 260′) (i.e., the portions that are not exposed or are covered by other components of the wall assembly (261) after wall assembly (261) is fully assembled) are made of non-fire resistant material. In other embodiments, various other portions of accessory (260, 260′) are made of fire resistant material. For instance, the entire accessory (260, 260′) can be made of fire resistant material, only one of the flanges (266. 266′) can be made of fire resistant material, or a smaller portion of central portion (264, 264′) can be made of fire resistant material.

In some embodiments, the fire resistant portion of framing accessory (260, 260′) can be formed with the non-fire resistant portion, such as by co-extrusion, so that the fire resistant portion and non-fire resistant portion are integrally connected to form a single unitary structure. In other embodiments where the entire framing accessory (260, 260′) is made of fire resistant material, the entire accessory can be extruded or co-extruded utilizing fire resistant material. Alternatively, the fire resistant portion of accessory (260, 260′) can be extruded or co-extruded and subsequently assembled with the non-fire resistant portion of accessory (260, 260′) using one or more of mechanical fasteners, adhesives, welding or any other suitable method or means of attachment. The body of framing accessory (260, 260′) may comprise a profile configured to allow the body, and particularly the portion(s) formed of fire resistant material, to expand into an adjacent space when the body is exposed to an elevated temperature. Still other suitable configurations for accessory (260, 260′) will be apparent to one with ordinary skill in the art in view of the teachings herein.

FIGS. 43-45 show another embodiment of a framing accessory (270) that is similar to framing accessory (260) that is a reveal control joint configured to provide stress relief and assist in controlling cracking in large areas of wallboard or finishing material, such as plaster or joint compound. FIG. 43 depicts a wall assembly (271) that includes framing accessory (270) positioned installed on a wallboard panel (70). As shown, framing accessory (270) comprise a body comprising a pair of perforated flanges (276) and a central portion (274) extending between flanges (276). Framing accessory (270) may be referred to as a “reverse reveal” because the recess in central portion (274) extends from flanges in the opposite direction compared to the recess in central portion (264) of framing accessory (260). Central portion (274) can vary in width to create different sized reveals in the wallboard. In the illustrated embodiment, central portion (274) comprises a recess to form a V-shape, but other suitable shapes for central portion (274) can be used. As shown, central portion (274) includes a pair of angled side walls (273) connected by a curved base member (275). In the illustrated embodiment, central portion (274) also includes a pair of lips (277) that extend from a free end of each of the pair of side walls (273). A portion of each lip (277) may extend in a plane that is substantially parallel relative to perforated flanges (276), while another portion of each lip (277) may extend in a direction away from the base member (275) in a plane that is substantially perpendicular to perforated flanges (276). As shown, each lip (277) is connected to a corresponding perforated flange (276).

As shown in FIG. 43, central portion (274) of accessory (270) is positioned on a mounting surface of a wallboard panel (70) such that flanges (276) are positioned over a corresponding portion of the mounting surface of wallboard panel (70). After framing accessory (270) is attached to the mounting surface of wallboard panel (70), joint compound or veneer plaster (72) can then be applied over perforated flanges (276) for a flush finish if desired.

In the illustrated embodiment, central portion (274) is made of fire resistant material (indicated by the cross-hatching), while flanges (276) are made of non-fire resistant material. As illustrated in FIG. 43, in this embodiment, the portion of framing accessory (270) that is exposed after it is installed in wall assembly (271) and wall assembly (271) is fully assembled is made of fire resistant material, while the remaining portions of framing accessory (270) (i.e., the portions that are not exposed or are covered by other components of the wall assembly (271) after wall assembly (271) is fully assembled) are made of non-fire resistant material. In other embodiments, various other portions of accessory (270) are made of fire resistant material. For instance, the entire accessory (270) can be made of fire resistant material, only one of the flanges (276) can be made of fire resistant material, or a smaller portion of central portion (274) can be made of fire resistant material.

In some embodiments, the fire resistant portion of framing accessory (270) can be formed with the non-fire resistant portion, such as by co-extrusion, so that the fire resistant portion and non-fire resistant portion are integrally connected to form a single unitary structure. In other embodiments where the entire framing accessory (270) is made of fire resistant material, the entire accessory can be extruded or co-extruded utilizing fire resistant material. Alternatively, the fire resistant portion of accessory (270) can be extruded or co-extruded and subsequently assembled with the non-fire resistant portion of accessory (270) using one or more of mechanical fasteners, adhesives, welding or any other suitable method or means of attachment. The body of framing accessory (270) may comprise a profile configured to allow the body, and particularly the portion(s) formed of fire resistant material, to expand into an adjacent space when the body is exposed to an elevated temperature. Still other suitable configurations for accessory (270) will be apparent to one with ordinary skill in the art in view of the teachings herein.

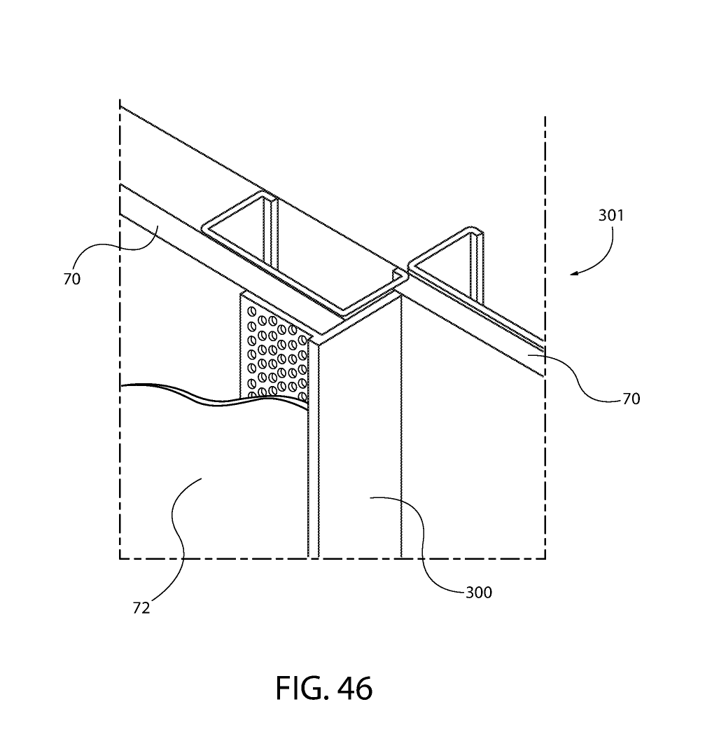

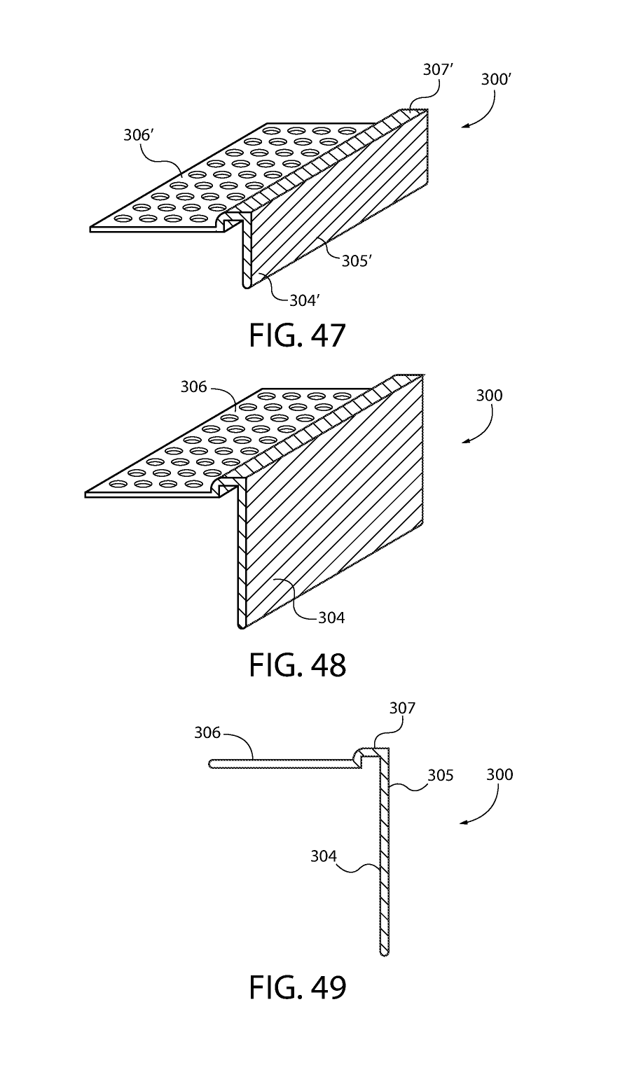

FIGS. 46 and 48-49 show another embodiment of a framing accessory (300) that is that is an L bead or stop bead configured to cover raw edges of a wallboard panel (70). FIG. 46 depicts a wall assembly (301) that includes framing accessory (300) installed at an intersection between two wallboard panels (70) that are laterally spaced apart from each other. FIG. 47 depicts an alternate embodiment of a framing accessory (300′) with a smaller reveal compared to the embodiment shown in FIGS. 46 and 48-49 (i.e., framing accessory (300)). Framing accessory (300′) is substantially identical to framing accessory (300), except that central portion (304′) has a smaller width relative to central portion (304). As shown, framing accessory (300, 300′) comprises a body comprising a central portion (304, 304′) with a perforated flange (306, 306′) extending outwardly from central portion (304, 304′). The width of central portion (304, 304′) can vary to accommodate different thicknesses of wallboard panel and to provide different size reveals. For instance, the width of central portion (304, 304′) can be between about ⅜ inches and about 3 inches.

In the illustrated embodiment, while the overall framing accessory (300, 300′) comprises a L-profile, central portion (304, 304′) comprises a J-profile that includes a reveal member (305, 305′) and a lip (307, 307′) that extends from one end of reveal member (305, 305′). A portion of lip (307, 307′) may extend in a plane that is substantially perpendicular relative to reveal member (305, 305′) and substantially parallel relative to perforated flange (306, 306′), while another portion of lip (307, 307′) may extend in a direction toward the opposite end of reveal member (305, 305′) in a plane that is substantially parallel relative to reveal member (305, 305′) and substantially perpendicular relative to perforated flange (306, 306′). As shown, lip (307, 307′) is connected to perforated flange (306, 306′).

As shown in FIG. 46, framing accessory (300, 300′) may be installed along a vertical edge of a wallboard panel (70) such that the reveal member (305, 305′) extends between two adjacent wallboard panels (70) to create a reveal. A portion of reveal member (305, 305′) may be positioned against a framing member, such as a stud. After a wallboard panel (70) is positioned within framing accessory (300, 300′), such that perforated flange (306, 306′) covers a portion of a surface of wallboard panel (70), joint compound or veneer plaster (72) can then be applied over perforated flange (306, 306′) for a flush finish if desired.

In the illustrated embodiment, central portion (304, 304′) is made of fire resistant material (indicated by the cross-hatching), while flange (306, 306′) is made of non-fire resistant material. As illustrated in FIG. 46, in this embodiment, the portion of framing accessory (300, 300′) that is exposed after it is installed in wall assembly (301) and wall assembly (301) is fully assembled is made of fire resistant material, while the remaining portions of framing accessory (300, 300′) (i.e., the portions that are not exposed or are covered by other components of the wall assembly (301) after wall assembly (301) is fully assembled) are made of non-fire resistant material. In other embodiments, various other portions of accessory (300, 300′) are made of fire resistant material. For instance, the entire accessory (300, 300′) can be made of fire resistant material, flange (306, 306′) can be made of fire resistant material, or a smaller portion of central portion (304, 304′) can be made of fire resistant material.

In some embodiments, the fire resistant portion of framing accessory (300, 300′) can be formed with the non-fire resistant portion, such as by co-extrusion, so that the fire resistant portion and non-fire resistant portion are integrally connected to form a single unitary structure. In other embodiments where the entire framing accessory (300, 300′) is made of fire resistant material, the entire accessory can be extruded or co-extruded utilizing fire resistant material. Alternatively, the fire resistant portion of accessory (300, 300′) can be extruded or co-extruded and subsequently assembled with the non-fire resistant portion of accessory (300, 300′) using one or more of mechanical fasteners, adhesives, welding or any other suitable method or means of attachment. The body of framing accessory (300, 300′) may comprise a profile configured to allow the body, and particularly the portion(s) formed of fire resistant material, to expand into an adjacent space when the body is exposed to an elevated temperature. Still other suitable configurations for accessory (300, 300′) will be apparent to one with ordinary skill in the art in view of the teachings herein.

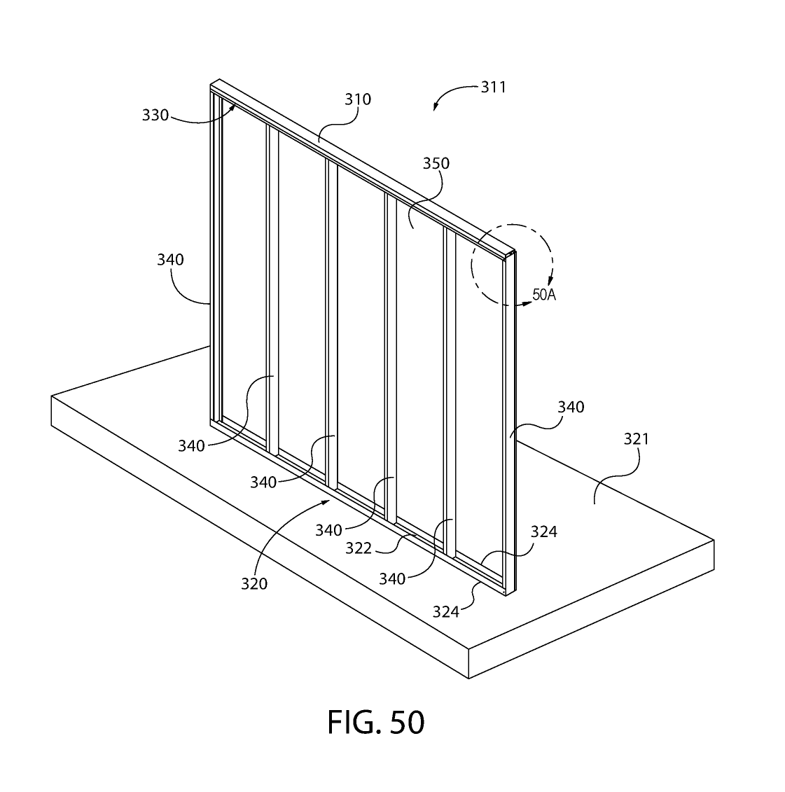

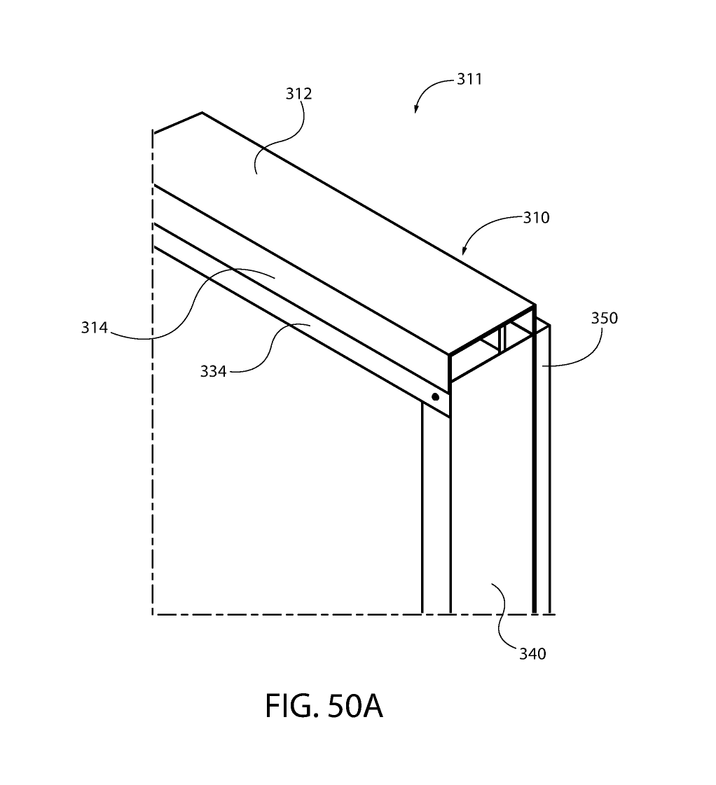

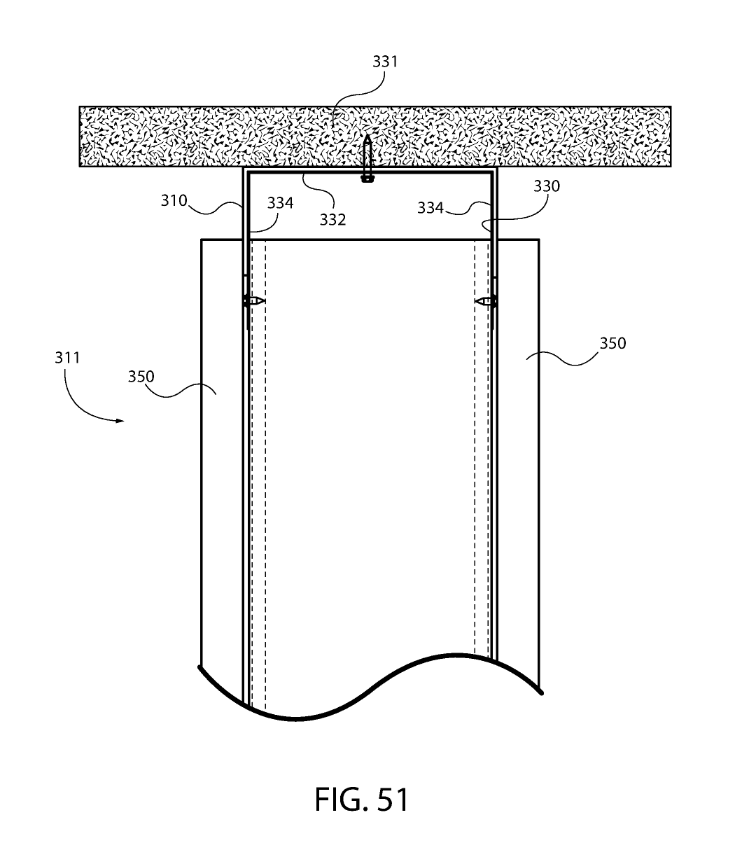

FIGS. 50-54A show another embodiment of a framing accessory (310) that is a cap configured to be installed as part of a fire-resistant head of wall assembly (311). FIGS. 50-51 depict a head of wall assembly (311) that is configured to seal a head of wall construction joint when head of wall assembly (311) is exposed to increased temperatures, such as those resulting from a fire. In the illustrated embodiment, head of wall assembly (311) comprises framing accessory (310), an elongated footer track (320), an elongated header track (330), a plurality of studs (340), and a plurality of wallboard panels (350). In FIGS. 50 and 50A, one of the wallboard panels (350) has been removed for ease of illustration. In other embodiments, wall assembly (311) may comprise more than one wallboard panel (350) on each side of the wall. In this embodiment, footer track (320) and header track (330) are vertically spaced apart from and aligned with each other in order to allow each of the plurality of studs (340) to extend vertically between footer track (320) and header track (330). Footer track (320) may be attached to a first horizontal support structure (321), such as a floor, while header track (330) may be attached to a second horizontal support structure (331), such as a ceiling. It will be appreciated that in a multi-story building the first and second horizontal support structures (321, 331) may serve as a ceiling for one floor of the building while also serving as a floor for an adjacent floor of the building. Horizontal support structures (321, 331) may comprise any suitable support structure, including but not limited to a concrete deck or a fluted metal deck.

In the illustrated embodiment, footer track (320) is an elongated channel member that comprises a web (322) connected to a pair of upwardly extending legs (324). Each of the legs (324) extend from a respective outer edge of web (322) to create an interior cavity defined by web (322) and legs (324). In this embodiment, legs (324) extend substantially perpendicular relative to web (322) which results in footer track having a substantially U-shaped cross-section. Similarly, in this embodiment, header track (330) is also an elongated channel member that comprises a web (332) connected to a pair downwardly extending legs (334). Each of the legs (334) extend from a respective outer edge of web (332) to create an interior cavity defined by web (322) and legs (324). In this embodiment, legs (334) extend substantially perpendicular relative to web (332) which results in header track (330) having a substantially U-shaped cross-section.

Footer track (320), header track (330) and studs (340) may be configured such that an upper end of each stud (340) is received within the interior cavity of header track (330) while a lower end of each stud (340) is received within the interior cavity of footer track (320). In some embodiments, each stud (340) may be installed such that there is a gap between the top of the stud (340) and the web (332) of the header track (330) and a gap between the bottom of the stud (340) and the web (322) of the footer track (320). That gap is preferably about ⅜ inches, but may comprise any suitable distance to allow for movement of the studs (340) relative to the header track (330) and footer track (320) after installation, which may result from a variety of factors, including but not limited to thermal expansion of studs (340). For example, the size of that gap may range from about ⅜ inches to about 3 inches. The height (H) of a leg (314) of framing accessory (310) (i.e., the distance from the exterior surface of web (312) to the lowermost or free edge of the leg (314)) may be larger than the gap between the upper end of studs (340) and the web (332) of the header track. One or more of footer track (320), header track (330), and studs (340) may comprise sheet metal, such as steel, stainless steel, aluminum or combinations thereof. In other embodiments, one or more of footer track (320), header track (330), and studs (340) may comprise plastics, other polymer-based or reinforced materials, or combinations thereof.

In the embodiment shown in FIGS. 50-54A, framing accessory (310) is an elongated channel member that comprises a body comprising a web (312) connected to a pair of downwardly extending legs (314). Each of the legs (314) extend from a respective outer edge of web (312) to create an interior cavity defined by web (312) and legs (314). In this embodiment, legs (314) extend substantially perpendicular relative to web (312) which results in framing accessory (310) having a substantially U-shaped cross-section. In some embodiments, the interior surface of each leg (314) may be substantially planar. In other words, legs (314) may be substantially free of any tabs or protrusions configured to engage legs (334) of header track (330). Each leg (314) comprises a fixed edge where leg (314) is connected to web (312) and a lowermost or free edge on the opposite end of leg (314). In some embodiments, one or both legs (314) may comprise a consistent thickness along the entire height of the leg (314) from the fixed edge to the free edge. In other embodiments, the thickness of one or both legs (314) may be tapered along the height (H) of the leg (314). For example, the thickness of one or both legs (314) may taper from a maximum thickness at or adjacent to the fixed edge of leg (314) toward a minimum thickness at or adjacent to the free end of leg (314). The tapering may start at the fixed edge of leg (314) or it could start at a point that is spaced apart from the fixed edge of leg (314).

As shown in FIGS. 50-51, head of wall assembly (311) includes framing accessory (310) installed between header track (330) and horizontal support structure (331). Framing accessory (310) may be secured in place when header track (330) is secured to support structure (331) in a conventional manner. For example, a plurality of fasteners, such as power actuated fasteners, self-tapping screws or other suitable mechanical fasteners, may be inserted through header track (330) into support structure (331) in a conventional manner. Due to the placement of framing accessory (310) between header track (330) and support structure (331), framing accessory (310) is also held in place and attached to support structure (331) by those same fasteners. Accordingly, framing accessory (310) may not require any additional steps or materials during installation.

In this embodiment, the outer surface of web (312) of framing accessory (310) is in contact with the underside of support structure (331) while the interior surface of web (312) of framing accessory (310) is in contact with the exterior surface of web (332) of header track (330). Legs (314) of framing accessory (310) extend downwardly along legs (334) of header track (330). As shown, the interior surface of legs (314) of framing accessory (310) contact the exterior surface of legs (334) of header track (330). In some embodiments, framing accessory (310) and header track (330) may be configured to provide a snap fit or friction fit between those two pieces when header track (330) is received within framing accessory (310). Each leg (314) of framing accessory (310) is positioned between a corresponding leg (334) of header track (330) and a corresponding wallboard panel (350). Specifically, in this embodiment, each wallboard panel (350) is positioned such that the upper edge of wallboard panel (350) is above the lowermost or free edge of the corresponding leg (314) of framing accessory (310). As a result, at least a portion of the exterior surface of leg (314), such as the portion adjacent to the free edge of leg (314), is in contact with the interior surface of the corresponding wallboard panel (350).

As shown in FIGS. 50-51, legs (334) of header track (330) are longer than legs (314) of framing accessory (310). Accordingly, when header track (330) is received within the interior cavity of framing accessory (310), a lower portion of each leg (334) of header track (330) extends beyond the lowermost or free edge of the corresponding leg (314) of framing accessory (310). In other words, each leg (334) of header track (330) comprises an upper portion that is adjacent to the juncture of leg (334) and web (332) of header track (330) and a lower portion located between the upper portion and the lowermost or free edge of each leg (334) of header track (330). In this embodiment, the upper portion of each leg (334) of header track (330) is covered by a corresponding leg (314) of framing accessory (310), while the lower portion of each leg (334) of header track (330) is not covered by the corresponding leg (334) of header track (330). In other embodiments, legs (314) of framing accessory (310) may be substantially as long or longer than legs (334) of header track (330). As a result, in those embodiments, substantially the entire leg (334) of header track (330) may be covered by a corresponding leg (314) of framing accessory (310). In those embodiments, header track (330) preferably comprises a standard track member (i.e., non-slotted or solid leg track).

Although the interior surface of legs (314) of framing accessory (310) contacts the exterior surface of legs (334) of header track (330), legs (314) of framing accessory (310) may be unattached to the corresponding leg (334) of header track (330). In other words, in some embodiments, legs (314) of framing accessory (310) may be substantially free of any adhesives, fasteners, tabs or other structures or materials configured to attach legs (314) of framing accessory (310) to either the outer surface or free edge of legs (334) of header track (330). Similarly, although the interior surface of web (312) of framing accessory (310) contacts the exterior surface of web (332) of header track (330), the interior surface of web (312) of framing accessory (310) may also be substantially free of any adhesives, tabs or other structures or materials configured to attach web (312) of framing accessory (310) to web (332) of header track (330), except for the conventional fastener that passes through both header track (330) and framing accessory (310) to secure both items to support structure (331). In other embodiments, an adhesive may be applied to the interior surface of one or both legs (314) of framing accessory (310).

In other embodiments, head of wall assembly (311) may include a framing accessory (310) installed between footer track (320) and horizontal support structure (321) in addition to or instead of having framing accessory (310) installed between header track (330) and horizontal support structure (331). In such an embodiment, the description contained herein regarding the relationship between framing accessory (310) and header track (330), including but not limited to the relationship between the lengths of legs (314) of framing accessory (310) and legs (334) of header track (330), would also apply to the relationship between framing accessory (310) and footer track (320).

The cross-section of framing accessory (310) may substantially correspond to or complement the cross-section of a corresponding header track (330) or footer track (320) depending on how framing accessory will be installed in a particular wall assembly. In some embodiments where framing accessory (310) is installed between a header track (330) and a horizontal support structure (331), framing accessory (310) may be sized and shaped to provide a tight fit between framing accessory (310) and header track (330). By way of example only, in those embodiments, framing accessory (310) may be sized and shaped such that, once the wall assembly is fully assembled and header track (330) is received within the interior cavity defined by web (312) and legs (314) of framing accessory (310), substantially the entire interior surface of web (312) of framing accessory (310) contacts substantially the entire exterior surface of web (332) of header track (330) and substantially the entire interior surface of each leg (314) of framing accessory (310) contacts a portion of the exterior surface of a corresponding leg (334) of header track (330). In particular, the interior surface of each leg (314) of framing accessory (310) may contact a portion of the exterior surface of a corresponding leg (334) that is adjacent to the juncture between the respective leg (334) and web (332) of header track (330). Furthermore, in those embodiments, the corner formed by each leg (314) and web (312) of framing accessory (310) may contact a corresponding corner of header track (330) formed by its web (332) and a respective leg (334). In some embodiments where framing accessory (310) is installed between a footer track (320) and a horizontal support structure (321), framing accessory (310) may be sized and shaped to provide a similar tight fit between framing accessory (310) and footer track (320).

In the illustrated embodiment, the entire framing accessory (310) is made of fire resistant material (indicated by the cross-hatching). In this embodiment, framing accessory (310) comprises fire resistant material across the entire thickness of legs (314) and web (312). Accordingly, if the outer surface of legs (314) or web (312) is scratched, then the underlying material still has fire resistant properties. As illustrated in FIGS. 50-51, a portion of framing accessory (310) that is made of fire resistant material is positioned adjacent to the gap between the upper edge of each wallboard panel (350) and support structure (331). As a result, when the fire resistant material is subjected to elevated temperatures and expands, the fire resistant material of framing accessory (310) may substantially fill in that gap.

In other embodiments, framing accessory (310) may comprise a combination of fire resistant material and non-fire resistant material. For instance, legs (314) of framing accessory (310) may comprise fire resistant material, while web (312) of framing accessory (310) comprises non-fire resistant material. In another embodiment, web (312) of framing accessory (310) may comprise fire resistant material, while legs (314) of framing accessory (310) comprise non-fire resistant material. In yet another embodiment, only one leg (314) may comprise fire resistant material, while web (312) and the other leg (314) comprise non-fire resistant material. In yet another embodiment, web (312) and one leg (314) of framing accessory (310) may comprise fire resistant material, while the other leg (314) of framing accessory (310) comprises non-fire resistant material. In some embodiments, the entire leg(s) (314) and/or web (312) may comprise fire resistant material, while in other embodiments only a portion of leg(s) (314) and/or web (312) may comprise fire resistant material. In embodiments where framing accessory (310) comprises a combination of fire resistant material and non-fire resistant material, in some embodiments at least a portion of the framing accessory (310) that is made of fire resistant material may be exposed after framing accessory (310) is installed in wall assembly (311) and wall assembly (311) is fully assembled, while at least a portion of framing accessory (310) that is made of non-fire resistant material may not be exposed (i.e., may be covered by other components of wall assembly (311), such as wallboard panel (350), header track (330), footer track (320), or horizontal support structure (321, 331)) after wall assembly (311) is fully assembled. With respect to head of wall assemblies, such as wall assembly (311), the wall assembly is considered to be fully assembled once framing accessory (310), footer track (320), header track (330), studs (340), and wallboard panel(s) (350) are installed. In some embodiments, the head of wall assembly may be finished by installing one or more finishing components, such as a trim piece or joint tape and joint compound, at the top of the wall assembly to cover the gap between wallboard panel(s) (350) and horizontal support structure (331). As a result, in those embodiments, framing accessory (310) may be covered once the wall assembly is finished.

In embodiments where the entire framing accessory (310) is made of fire resistant material, the entire accessory can be formed utilizing fire resistant material, such as by molding, injection molding, extrusion, or co-extrusion, so that the web (312) and legs (314) are integrally connected to form a single unitary structure. Additionally, in some other embodiments where framing accessory (310) comprises both fire resistant material and non-fire resistant material, the fire resistant portion of framing accessory (310) can be formed with the non-fire resistant portion, such as by co-extrusion, so that the fire resistant portion and non-fire resistant portion are integrally connected to form a single unitary structure. Alternatively, in some embodiments where framing accessory (310) comprises both fire resistant material and non-fire resistant material, the fire resistant portion of accessory (310) can be extruded or co-extruded and subsequently assembled with the non-fire resistant portion of accessory (310) using one or more of mechanical fasteners, adhesives, welding or any other suitable method or means of attachment. The body of framing accessory (310) may comprise a profile configured to allow the body, and particularly the portion(s) formed of fire resistant material, to expand into an adjacent space when the body is exposed to an elevated temperature. Still other suitable configurations for accessory (310) will be apparent to one with ordinary skill in the art in view of the teachings herein.

As discussed above, the fire resistant material in framing accessory (310) may provide sufficient strength and rigidity by itself such that framing accessory (310) comprises a single unitary structure that does not require either an additional reinforcing member/layer on the fire resistant portion(s) or that the fire resistant material be applied to a separate substrate. In addition, in some embodiments, framing accessory (310) is sufficiently rigid such that it maintains its cross-sectional profile (e.g., the U-shaped profile shown in FIGS. 50-54A) even without any other wall assembly components being installed against legs (314) of framing accessory (310). In other words, framing accessory (310) may be sufficiently rigid such that it maintains its U-shaped cross-sectional profile before wallboard panels (350) are installed against legs (314) in wall assembly (311). Furthermore, unlike intumescent tape or putty used in some prior art devices, the portion(s) of framing accessory (310) made out of fire resistant material may be substantially incompressible. The substantially incompressible quality of framing accessory (310) in these embodiments may help prevent the fire resistant material from being scratched or gouged during shipping and/or installation.

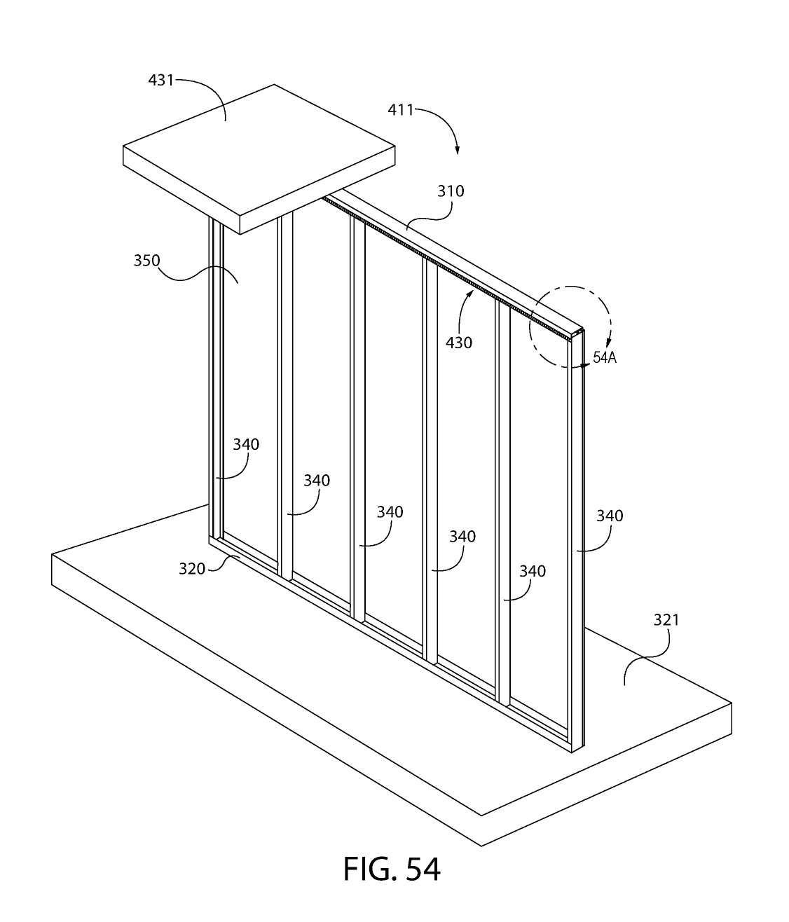

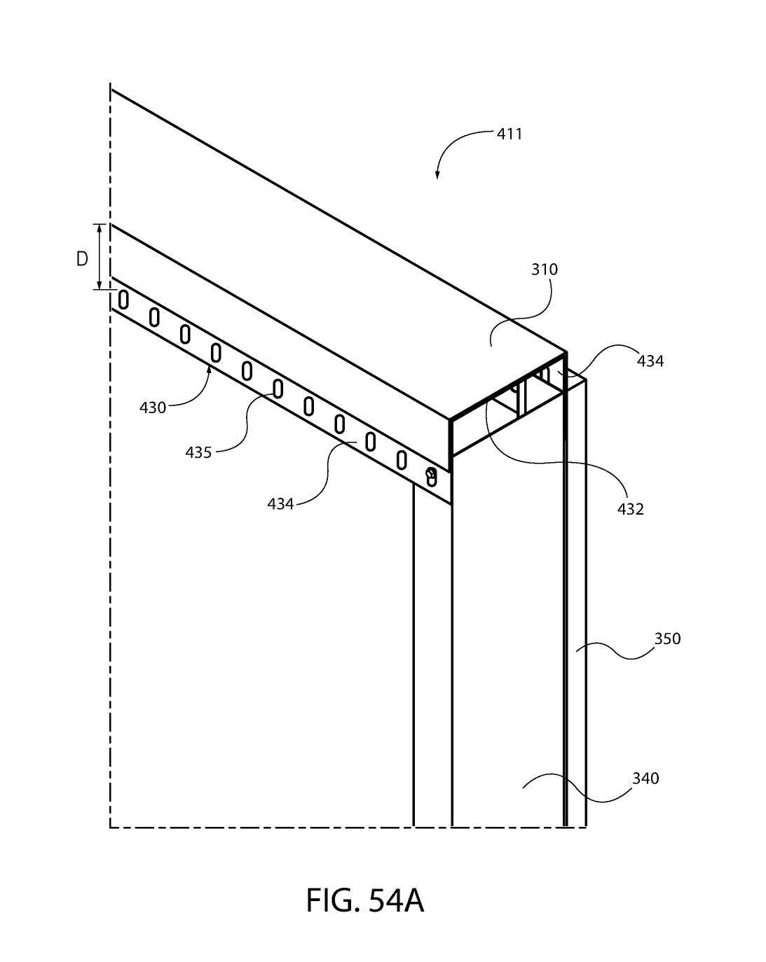

Framing accessory (310) may be used with either standard header and footer tracks (i.e., non-slotted or solid leg tracks) or slotted header and footer tracks. FIGS. 54 and 54A depict an alternate head of wall assembly (411) that includes slotted header track (430). Header track (430) is substantially identical to header track (330), except that header track (430) includes a plurality of vertically oriented and longitudinally spaced slots (435) in each leg (434). In embodiments like wall assembly (411) that utilize slotted track members, such as header track (430), each stud (340) is attached to header track (430) via a fastener installed in a respective slot (435). Studs (340) may be installed such that there is a gap between the upper end of each stud (340) and the interior surface of web (432) of header track (430). That gap may be about one-half of the height of each slot (435). By way of example only, in these embodiments the gap between the top of each stud (340) and web (432) of header track (430) may be about ⅜ inches to about 3 inches or any other amount suitable to provide the desired amount of deflection, and the height of each slot may be about 1.5 inches or any other height suitable to provide the desired amount of deflection. Studs (340) may be installed such that the fastener is positioned at approximately the mid-way point of the height of the slot (435). The combination of the slots (435) and the gap between the top end of studs (340) and header track (430) may allow wall assembly (411) to accommodate ceiling deflections. Similar to wall assembly (311) described above, in wall assembly (411) framing accessory (310) is installed between header track (430) and horizontal support structure (431).

As shown in FIGS. 54 and 54A, legs (434) of header track (430) are longer than legs (314) of framing accessory (310). Accordingly, when header track (430) is received within the interior cavity of framing accessory (310), a lower portion of each leg (434) of header track (430) extends beyond the lowermost or free edge of the corresponding leg (314) of framing accessory (310). In other words, each leg (434) of header track (430) comprises an upper portion that is adjacent to the juncture of leg (434) and web (432) of header track (430) and a lower portion located between the upper portion and the lowermost or free edge of each leg (434) of header track (430). In this embodiment, the upper portion of each leg (434) of header track (430) is covered by a corresponding leg (314) of framing accessory (310), while the lower portion of each leg (434) of header track (430) is not covered by the corresponding leg (334) of header track (330). As shown, slots (435) are located in the lower portion of each leg (434) of header track (430) and the free edge of each leg (314) of framing accessory (310) is positioned at or above the top of each of slots (435) between the top of slots (435) and the juncture of the corresponding leg (434) and web (432) of header track (430). In other words, the height (H) of each leg (314) of framing accessory (310) is less than or about equal to the distance (D) from the exterior surface of web (432) to the top of slots (435). Accordingly, legs (314) of framing accessory (310) do not cover slots (435) in order to allow a full range of motion for the fasteners installed in slots (435).

An exemplary method of installing a head of wall assembly, such as wall assembly (311, 411), may include the following steps. A U-shaped header track (330, 430) may be received into an interior cavity of a corresponding U-shaped framing accessory (310). The header track (330, 430) and framing accessory (310) assembly may then be attached to a horizontal support structure (331, 431) in a conventional manner, such as by inserting fasteners through header track (330, 430) and framing accessory (310) into support structure (331, 431). A U-shaped footer track (320) may then be aligned with and vertically spaced apart from header track (330, 430) and attached to a horizontal support structure (321) in a conventional manner, such as by inserting fasteners through footer track (320) into support structure (321). Alternatively, footer track (320) may be positioned first and the header track (330, 430) and framing accessory (310) assembly may subsequently be installed and aligned with the footer track (320).

A plurality of studs (340) may be installed vertically between header track (330, 430) and footer track (320) such that a top end of each stud (340) is received into the interior cavity of header track (330, 430) and a bottom end of each stud (340) is received into the interior cavity of footer track (320). Studs (340) may be installed such that an appropriate gap is left between the top end of each stud (340) and web (332, 432) of header track (330, 430). An appropriate gap may also be left between the bottom end of each stud (340) and web (322) of footer track (320). In embodiments that include a slotted track member, such as header track (430), each stud (340) may be installed in header track (430) by inserting a fastener through a slot (435) in header track (430) adjacent to each stud (340) and into a side wall of stud (340). In other embodiments that include a standard (i.e., non-slotted or solid leg) track member, each stud (340) may be installed in header track (330) by inserting a fastener through leg (334) of header track (330) and into a side wall of stud (340). The fasteners used to attach each stud (340) to header track (330, 430) may be positioned below the lowermost or free edge of the corresponding leg (314) of framing accessory (310) such that those fasteners pass through the corresponding leg (334) of header track (330) or slot (435) of leg (434) of header track (430) and a side wall of each stud (340) without passing through a leg (314) of framing accessory (310).

Once the studs (340) have been installed, then wallboard panels (350) may be installed. In some embodiments, one or more wallboard panels (350) may be installed on only one side of wall assembly (311, 411), while in other embodiments one or more wallboard panels (350) may be installed on both sides of wall assembly (311, 411). Wallboard panels (350) may be installed in a conventional manner, such as by inserting fasteners through wallboard panels (350) and into a corresponding side wall of a stud (340). Each wallboard panel (350) may be positioned such that the upper edge of the wallboard panel (350) is above the lowermost or free edge of a corresponding leg (314) of framing accessory (310), which may allow an interior surface of the wallboard panel (350) to be in contact with the exterior surface of the corresponding leg (314) of framing member (310). Such overlap between wallboard panels (350) and framing accessory (310) may be possible in embodiments where the height (H) of a leg (314) of framing accessory (310) is larger than the gap between the upper edge of the corresponding wallboard panel (350) and support structure (331, 431). In some embodiments, a portion of the exterior surface of at least one leg (314) of framing accessory (310) may be exposed to the gap between the upper edge of a corresponding wallboard panel (350) and support structure (331, 431). Accordingly, when wall assembly (311, 411) is subjected to a heat source, such as a fire, the fire resistant material in framing accessory (310) may cause framing accessory (310) to expand and substantially fill the gap between the upper edge of the adjacent wallboard panel (350) and support structure (331, 431). Wallboard panels (350) may slide along the exterior surface of a corresponding leg (314) of framing accessory (310) during ceiling deflections. In embodiments where one or both legs (314) of framing accessory (310) are tapered toward a minimum thickness at or adjacent to the free end of leg (314), the tapering may facilitate the sliding of a wallboard panel (370) along the exterior surface of a corresponding leg (314). In some embodiments, the head of wall assembly may be finished by installing one or more finishing components, such as a trim piece or joint tape and joint compound, at the top of the wall assembly to cover the gap between wallboard panel(s) (350) and horizontal support structure (331).

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of any claims that may be presented and is understood not to be limited to the details of structure and operation shown and described in the specification and drawings.

What is claimed is:

1. A framing accessory comprising:
a body, wherein substantially the entire body is formed of a fire resistant material, wherein the fire resistant material comprises a structural component and a fire resistant component that are substantially homogeneously combined, wherein the body comprises a profile that is configured to allow the body to expand into an adjacent space when the body is exposed to an elevated temperature.

2. The framing accessory of claim 1, wherein the profile is selected from the group consisting of a profile for an expansion joint, a profile for a channel reveal, a profile for a ceiling trim, a profile for a shadow reveal, a profile for a control joint, a profile for a reveal control joint, a profile for an L-bead, a profile for a stop bead, and a profile for a cap.

3. The framing accessory of claim 1, wherein the structural component of the fire resistant material comprises a plastic.

4. The framing accessory of claim 1, wherein the structural component of the fire resistant material comprises polyvinyl chloride.

5. The framing accessory of claim 4, wherein the fire resistant component of the fire resistant material comprises a nanocomposite material with fire resistant properties.

6. The framing accessory of claim 1, wherein the fire resistant component of the fire resistant material comprises a nanocomposite material with fire resistant properties.

7. The framing accessory of claim 1, wherein the structural component of the fire resistant material comprises a thermoplastic.

8. A wall assembly comprising:
a framing accessory, wherein the framing accessory comprises a first leg, a second leg and a web extending between the first leg and the second leg, wherein at least one of the first leg, the second leg, and the web is at least partially formed of a fire resistant material, wherein the fire resistant material comprises a structural component and a fire resistant component that are substantially homogeneously combined, wherein the first leg, the second leg and the web define an interior cavity, wherein the first leg is connected to the web along a first edge and comprises a free edge that is opposite the first edge; and
a track member, wherein the track member comprises a first track leg, a second track leg and a track web extending between the first track leg and the second track leg, wherein at least a portion of the track member is received within the interior cavity of the framing accessory such that the first track leg extends beyond the free edge of the first leg of the framing accessory.

9. The wall assembly of claim 8, wherein the track member is selected from the group consisting of a header track and a footer track.

10. The wall assembly of claim 8, wherein substantially the entire framing accessory is formed of the fire resistant material.

11. The wall assembly of claim 8, wherein the structural component of the fire resistant material comprises polyvinyl chloride and the fire resistant component comprises a nanocomposite material with fire resistant properties.

12. The wall assembly of claim 8, wherein the first track leg of the track member comprises a plurality of slots.

13. The wall assembly of claim 12, wherein the free edge of the first leg of the framing accessory is positioned between a top of the plurality of slots and a juncture between the first track leg and the track web.

14. The wall assembly of claim 8, wherein the first leg of the framing accessory is adjacent to but unattached to the first track leg of the track member.

15. The wall assembly of claim 8, wherein the first leg, the second leg, and the web of the framing accessory are integrally connected to form a single unitary structure.

16. The wall assembly of claim 8, wherein the framing accessory comprises a substantially U-shaped profile.

17. The wall assembly of claim 8, wherein at least one of the first leg, the second leg, and the web of the framing accessory is at least partially formed of a non-fire resistant material.

18. The wall assembly of claim 17, wherein the first leg, the second leg, and the web are coextruded together.

19. A control joint comprising
a central portion, wherein the central portion comprises a first side wall and a second side wall connected by a curved base member, wherein at least one of the first side wall, the second side wall and the base member is at least partially formed of a fire resistant material, wherein the fire resistant material comprises a structural component and a fire resistant component that are substantially homogeneously combined; and
a first perforated flange, wherein the first perforated flange is connected to the central portion.

20. The control joint of claim 19, wherein the central portion further comprises a first lip connected to the first side wall, wherein at least a portion of the first lip is formed of the fire resistant material.

21. The control joint of claim of claim 20, wherein the first perforated flange is connected to the first lip.

22. The control joint of claim 19, wherein the central portion further comprises a first lip connected to the first side wall and a second lip connected to the second side wall, wherein at least a portion of the second lip is formed of the fire resistant material.

23. The control joint of claim 22, further comprising a second perforated flange connected to the second lip.

24. The control joint of claim 19, wherein substantially the entire central portion is formed of the fire resistant material and substantially the entire perforated flange is formed of the fire resistant material.

25. The control joint of claim 19, wherein the structural component of the fire resistant material comprises polyvinyl chloride and the fire resistant component comprises a nanocomposite material with fire resistant properties.

26. The control joint of claim 19, wherein the first perforated flange is at least partially formed of a non-fire resistant material.

27. The control joint of claim 26, wherein the central portion and the perforated flange are coextruded together.
